(19) United States
(12) Patent Application Publication
(10) Pub. No.: US 2009/0300240 A1
(43) Pub. Date: Dec. 3, 2009

(54) COMPUTING UNIT AND IMPLEMENTATION THEREOF

(75) Inventor: AHMADREZA (REZA) ROFOUGARAN, NEWPORT COAST, CA (US)

Correspondence Address: GARLICK HARRISON & MARKISON, P.O. BOX 160727, AUSTIN, TX, 78716-0727, US

(73) Assignee: BROADCOM CORPORATION, IRVINE, CA (US)

(21) Appl. No.: 12/431,502

(22) Filed: Apr. 28, 2009

Related U.S. Application Data
(63) Continuation-in-part of application No. 12/026,681, filed on Feb. 6, 2008.

(51) Int. Cl. G06F 13/38

(52) U.S. Cl. 710/65

(57) ABSTRACT

A computing unit includes main memory, a processing module, a baseband processing module, a transmission section, and a control module. The control module includes inputs, outputs, and memory interfaces. The main memory is coupled to one of the memory interfaces. The processing module is coupled to one of the inputs and to one of the outputs. The baseband processing module is coupled to another one of the inputs and to another one of the outputs. The control module is operably coupled to receive a request via a input of the plurality of inputs and to interpret the request. The control module determines an address from the memory access request when the request is a memory access request. The control module then determines a memory interface based on the address and transmits a representation of the memory access request to the memory interface.

This patent application is claiming priority under 35 USC § 120 as a continuation in part patent application of co-pending patent application entitled COMPUTING DEVICE WITH HANDHELD AND EXTENDED COMPUTING UNITS, having a filing date of Feb. 6, 2008.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Technical Field of the Invention

This invention relates generally to communication systems and more particularly to computing devices used in such communication systems.

2. Description of Related Art

Communication systems are known to support wireless and wire lined communications between wireless and/or wire lined communication devices. Such communication systems range from national and/or international cellular telephone systems to the Internet to point-to-point in-home wireless or wired networks. The wireless and/or wire lined communication devices may be personal computers, laptop computers, personal digital assistants (PDA), cellular telephones, personal digital video players, personal digital audio players, global positioning system (GPS) receivers, video game consoles, entertainment devices, etc.

Many of the communication devices include a similar basic architecture: that being a processing core, memory, and peripheral devices. In general, the memory stores operating instructions that the processing core uses to generate data, which may also be stored in the memory. The peripheral devices allow a user of the communication device to direct the processing core as to which operating instructions to execute, to enter data, etc. and to see the resulting data. For example, a personal computer includes a keyboard, a mouse, and a display, which a user uses to cause the processing core to execute one or more of a plurality of applications.

While the various communication devices have a similar basic architecture, they each have their own processing core, memory, and peripheral devices and provide distinctly different functions. For example, a cellular telephone is designed to provide wireless voice and/or data communications in accordance with one or more wireless communication standards (e.g., IEEE 802.11, Bluetooth, advanced mobile phone services (AMPS), digital AMPS, global system for mobile communications (GSM), code division multiple access (CDMA), local multi-point distribution systems (LMDS), multi-channel-multi-point distribution systems (MMDS), radio frequency identification (RFID), Enhanced Data rates for GSM Evolution (EDGE), General Packet Radio Service (GPRS), and/or variations thereof). As another example, a personal digital audio player is designed to decompress a stored digital audio file and render the decompressed digital audio file audible.

Over the past few years, integration of the some of the communication device functions into a single device has occurred. For example, many cellular telephones now offer personal digital audio playback functions, PDA functions, and/or GPS receiver functions. Typically, to load one or more of these functions, files, or other applications onto a handheld communication device (e.g., a cellular telephone, a personal digital audio and/or video player, a PDA, a GPS receiver), the handheld communication device needs to be coupled to a personal computer or laptop computer. In this instance, the desired application, function, and/or file is first loaded on to the computer and then copied to the handheld communication device; resulting in two copies of the application, function, and/or file.

To facilitate such loading of the application, function, and/or file in this manner, the handheld communication device and the computer each require hardware and corresponding software to transfer the application, function, and/or file from the computer to the handheld communication device. As such, two copies of the corresponding software exist as well as having two hardware components (one for the handheld device and the second for the computer). In addition to the redundancy of software, timing issues, different versions of the software, incompatible hardware, and a plethora of other reasons cause the transfer of the application, function, and/or file to fail.

In addition to integration of some functions into a single handheld device, handheld digital audio players may be docked into a speaker system to provide audible signals via the speakers as opposed to a headphone. Similarly, a laptop computer may be docked to provide connection to a full size keyboard, a separate monitor, a printer, and a mouse. In each of these docking systems, the core architecture is not changed.

Therefore, a need exists for a computing device having a computing unit that at least partially overcomes one or more of the above mentioned issues.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE SEVERAL VIEWS OF THE DRAWING(S)

FIG. 1 is a diagram of an embodiment of a computing device that includes a handheld computing unit and an extended computing unit in accordance with the present invention;

FIG. 2 is a schematic block diagram of an embodiment of a handheld computing unit docked to an extended computing unit within a communication system in accordance with the present invention;

FIG. 3 is a schematic block diagram of an embodiment of a handheld computing unit docked to an extended computing unit in accordance with the present invention;

FIG. 4 is a schematic block diagram of another embodiment of a handheld computing unit docked to an extended computing unit in accordance with the present invention;

FIG. 5 is a schematic block diagram of another embodiment of a handheld computing unit docked to an extended computing unit in accordance with the present invention;

FIG. 6 is a schematic block diagram of another embodiment of a handheld computing unit docked to an extended computing unit in accordance with the present invention;

FIG. 7 is a schematic block diagram of an embodiment of a portion of a handheld computing unit in accordance with the present invention;

FIG. 8 is a schematic block diagram of an embodiment of a control module coupled to handheld and/or extended computing unit components in accordance with the present invention;

FIG. 9 is a schematic block diagram of an embodiment of an interface matrix coupled to handheld and/or extended computing unit components in accordance with the present invention;

FIG. 10 is a logic diagram of an embodiment of a control module method in accordance with the present invention;

FIG. 11 is a logic diagram of a further embodiment of the control module method in accordance with the present invention;

FIG. 12 is a diagram of an example of control module mapping in accordance with the present invention;

FIG. 13 is a diagram of an example of memory mapping in accordance with the present invention;

FIG. 14 is a logic diagram of a further embodiment of the control module method in accordance with the present invention;

FIG. 15 is a logic diagram of an embodiment of an interface module method in accordance with the present invention;

FIG. 16 is a logic diagram of a further embodiment of the interface module method in accordance with the present invention;

FIG. 17 is a schematic block diagram of an example of the computing device executing a cellular telephone call in accordance with the present invention;

FIG. 18 is a schematic block diagram of another example of the computing device executing a cellular telephone call in accordance with the present invention; and

FIG. 19 is a schematic block diagram of an example of the computing device executing video graphics processing in accordance with the present invention.

### DETAILED DESCRIPTION OF THE INVENTION

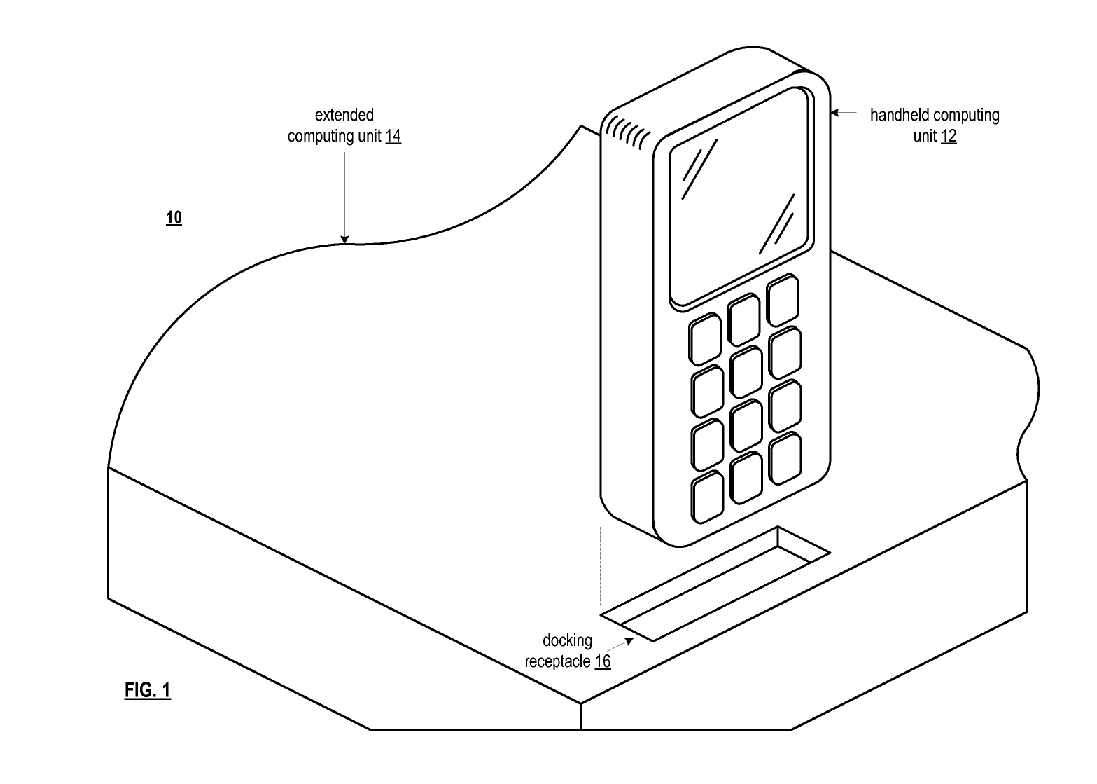

FIG. 1 is a diagram of an embodiment of a computing device 10 that includes a handheld computing unit 12 and an extended computing unit 14. The handheld computing unit 12 may have a form factor similar to a cellular telephone, personal digital assistant, personal digital audio/video player, etc. and includes a connector structure that couples to a docketing receptacle 16 of the extended computing unit 14.

In general, the handheld computing unit 12 includes the primary processing module (e.g., central processing unit), the primary main memory, and the primary hard disk memory for the computing device 10. In this manner, the handheld computing unit 12 functions as the core of a personal computer (PC) or laptop computer when it is docked to the extended computing unit and functions as a cellular telephone, a GPS receiver, a personal digital audio player, a personal digital video player, a personal digital assistant, and/or other handheld electronic device when it is not docked to the extended computing unit.

In addition, when the handheld computing unit 12 is docked to the extended computing unit 14, files and/or applications can be swapped therebetween. For example, assume that the user of the computing device 10 has created a presentation using presentation software and both reside in memory of the extended computing unit 14. The user may elect to transfer the presentation file and the presentation software to memory of the handheld computing unit 12. If the handheld computing unit 12 has sufficient memory to store the presentation file and application, then it is copied from the extended computing unit memory to the handheld computing unit memory. If there is not sufficient memory in the handheld computing unit, the user may transfer an application and/or file from the handheld computing unit memory to the extended computing unit memory to make room for the presentation file and application.

With the handheld computing unit 12 including the primary components for the computing device 10, there is only one copy of an application and/or of a file to support PC functionality, laptop functionality, and a plurality of handheld device functionality (e.g., TV, digital audio/video player, cell phone, PDA, GPS receiver, etc.). In addition, since only one copy of an application and/or of a file exists (other than desired backups), special software to transfer the applications and/or files from a PC to a handheld device is no longer needed. As such, the processing module, main memory, and I/O interfaces of the handheld computing unit 12 provide a single core architecture for a PC and/or a laptop, a cellular telephone, a PDA, a GPS receiver, a personal digital audio player, a personal digital video player, etc.

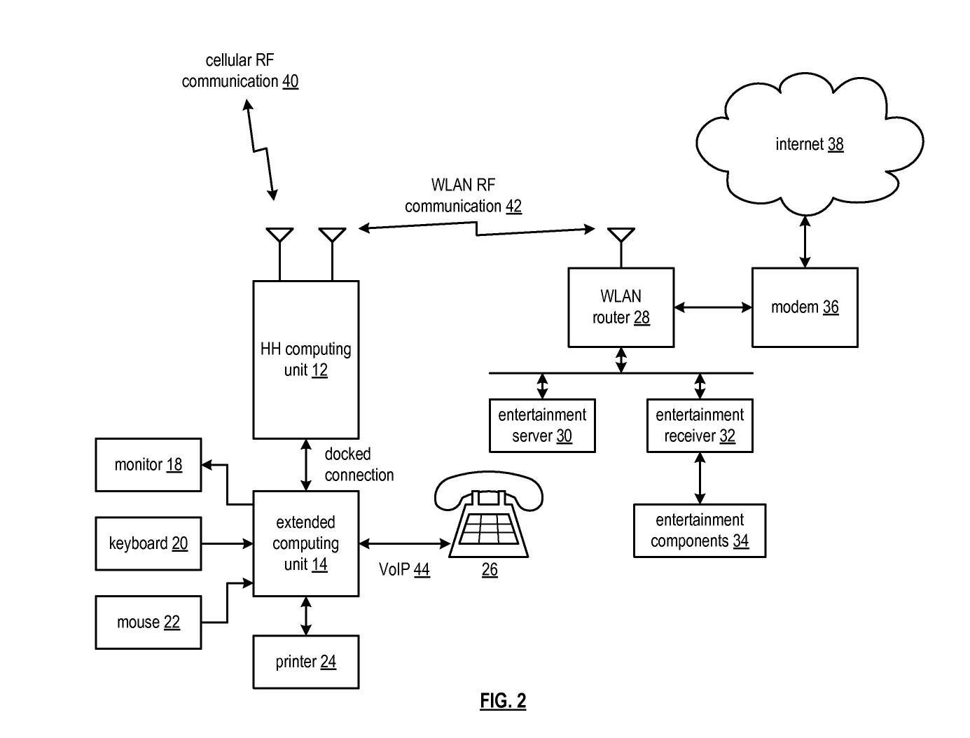

FIG. 2 is a schematic block diagram of an embodiment of a handheld computing unit 12 docked to an extended computing unit 14 within a communication system. In this embodiment, the communication system may include one or more of a wireless local area network (WLAN) router 28, a modem 36 coupled to the internet 38, an entertainment server 30 (e.g., a server coupled to database of movies, music, video games, etc.), an entertainment receiver 32, entertainment components 34 (e.g., speaker system, television monitor and/or projector, DVD (digital video disc) player or newer versions thereof, VCR (video cassette recorder), satellite set top box, cable set top box, video game console, etc.), and a voice over internet protocol (VoIP) phone 26. As an alternative or in addition to the WLAN router 28, the system may include a local area network (LAN) router coupled to the extended computing unit 14.

As is also shown, the extended computing unit 14 is coupled to a monitor 18, a keyboard, a mouse 22, and a printer 24. The extended computing unit 14 may also be coupled to other devices (not shown) such as a trackball, touch screen, gaming devices (e.g., joystick, game pad, game controller, etc.), an image scanner, a webcam, a microphone, speakers, and/or a headset. In addition, the extended computing unit 14 may have a form factor similar to a personal computer and/or a laptop computer. For example, for in-home or in-office use, having the extended computing unit with a form factor similar to a PC may be desirable. As another example, for traveling users, it may be more desirable to have a laptop form factor.

In this example, the handheld computing unit 12 is docked to the extended computer unit 14 and function together to provide the computing device 10. The docking of the handheld computing unit 12 to the extended computing unit 14 encompasses one or more high speed connections between the units 12 and 14. Such a high speed connection may be provided by an electrical connector, by an RF connector (an example is discussed with reference to FIG. 45), by an electromagnetic connector (an example is discussed with reference to FIG. 46), and/or a combination thereof. In this mode, the handheld computing unit 12 and the extended computing 14 collectively function similarly to a personal computer and/or laptop computer with a WLAN card and a cellular telephone card.

In this mode, the handheld computing unit 12 may transceive cellular RF communications 40 (e.g., voice and/or data communications). Outgoing voice signals may originate at the VoIP phone 26 as part of a VoIP communication 44 or a microphone coupled to the extended computing unit 14. The outgoing voice signals are converted into digital signals that are subsequently converted to outbound RF signals. Inbound RF signals are converted into incoming digital audio signals and that may be provided to a sound card within the extended computing unit for presentation on speakers or provided to the VoIP phone via as part of a VoIP communication 44.

Outgoing data signals may originate at the mouse 22, keyboard 20, image scanner, etc. coupled to the extended computing unit 14. The outgoing data signals are converted into digital signals that are subsequently converted to outbound RF signals. Inbound RF signals are converted into incoming data signals and that may be provided to the monitor 18, the printer 24, and/or other character presentation device.

In addition, the handheld computing unit 12 may provide a WLAN transceiver for coupling to the WLAN router 28 to support WLAN RF communications 42 for the computing device 10. The WLAN communications 42 may be for accessing the internet 38 via modem 36, for accessing the entertainment server, and/or accessing the entertainment receiver 32. For example, the WLAN communications 42 may be used to support surfing the web, receiving emails, transmitting emails, accessing on-line accounts, accessing on-line games, accessing on-line user files (e.g., databases, backup files, etc.), downloading music files, downloading video files, downloading software, etc. As another example, the computing device 10 (i.e., the handheld computing unit 12 and the extended computing unit 14) may use the WLAN communications 42 to retrieve and/or store music and/or video files on the entertainment server; and/or to access one or more of the entertainment components 34 and/or the entertainment receiver 32.

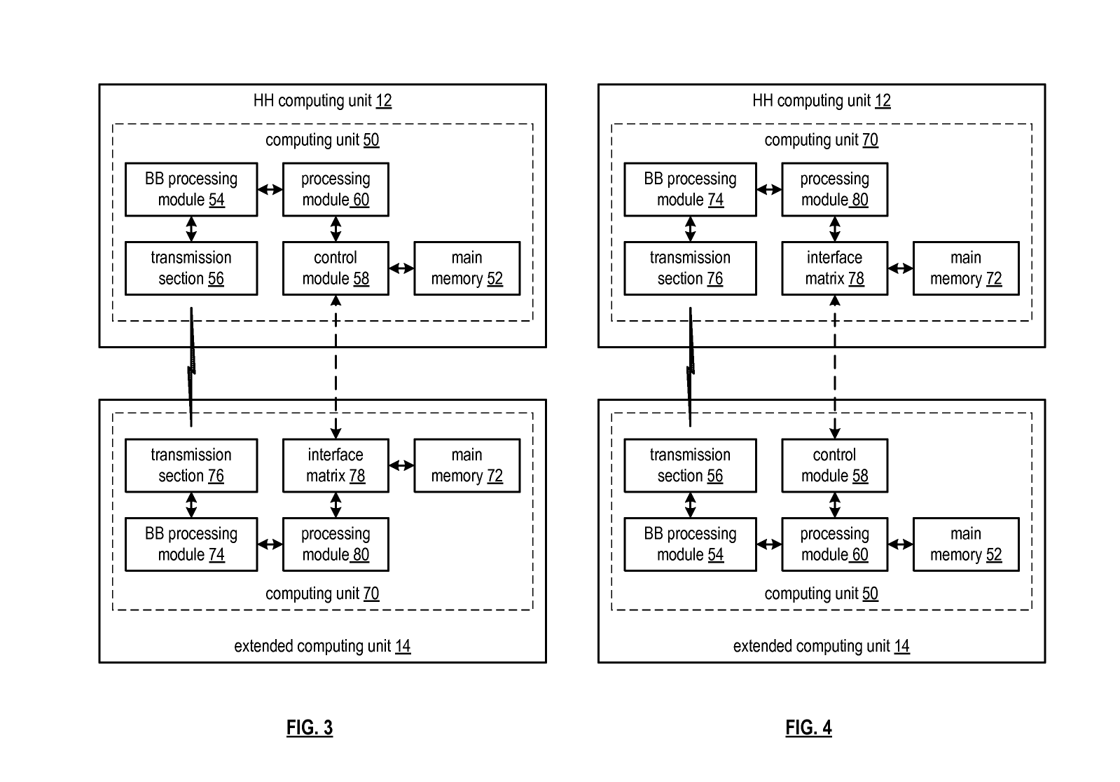

FIG. 3 is a schematic block diagram of an embodiment of a handheld (HH) computing unit 12 docked to an extended (EXT) computing unit 14 to provide a core of the computing device 10. The HH computing unit 12 includes a computing unit 50 and the EXT computing unit includes a computing unit 70. The computing unit 50 includes a processing module 60, a control module 58, a baseband (BB) processing module 54, a transmission section 56, and a main memory 52. The computing unit 70 includes a processing module 80, an interface matrix 78, a BB processing module 74, a transmission section 76, and a main memory 72.

The processing module 60 and the BB processing module 54 may be separate processing modules or the same processing module. Similarly, processing module 80 and BB processing module 74 may be separate processing modules or the same processing module. Each of the processing modules may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module may have an associated memory and/or memory element, which may be a single memory device, a plurality of memory devices, and/or embedded circuitry of the processing module. Such a memory device may be a read-only memory, random access memory, volatile memory, non-volatile memory, static memory, dynamic memory, flash memory, cache memory, and/or any device that stores digital information. Note that when the processing module implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Further note that, the memory element stores, and the processing module executes, hard coded and/or operational instructions corresponding to at least some of the steps and/or functions illustrated in FIGS. 1-19.

As an example of operation, processing module 60 utilizes processing module 80 in a multiprocessing system manner, as a co-processor, or not at all. For instance, when the computing device 10 is executing one or more user applications (e.g., word processing, spreadsheet processing, presentation processing, email, web browsing, database, calendar, video games, digital audio playback, digital video playback, digital audio record, digital video record, video games, contact management program, notes, web favorites, money management program, etc.), the processing modules 60 and 80 function as a multiprocessing module and the main memories 52 and 72 function as combined main memory.

In this example, the processing modules 60 and 80 may share tasks and/or execute multiple concurrent software processes. Further, the processing modules 60 and 80 may be equal; one may be reserved for one or more special purposes; may be tightly coupled; may be loosely coupled; etc. For example, at the operating system level, the processing module 60 may be designated to respond to all interrupts, traps, and/or services calls and invoke the processing module 80 as needed. As another example, at the user level, the processing modules may function in a symmetrical multiprocessing mode, in an asymmetrical multiprocessing mode, in a non-uniform memory access multiprocessing mode, and/or in a clustered multiprocessing mode.

With respect to instruction and data streams, the processing modules 60 and 80 may execute a single sequence of instructions in multiple contexts (single-instruction, multiple-data or SIMD), multiple sequences of instructions in a single context (multiple-instruction, single-data or MISD), or multiple sequences of instructions in multiple contexts (multiple-instruction, multiple-data or MIMD).

The computing device 10 incorporates a virtual memory technique, overlays, and/or swapping to utilize the combined main memories. In an embodiment, the virtual memory is divided into pages (e.g., a 4K-Byte block), where one or more page tables (e.g., one for the computing device, one for each running user application, etc.) translates the virtual address into a physical address. Note that the memory controller manages accesses to the one or more page tables to facilitate the fetching of data and/or instructions from physical memory. If a page table indicates that a page is not currently in memory, the memory controller and/or one of the processing modules 60 and/or 80 raise a page fault interrupt.

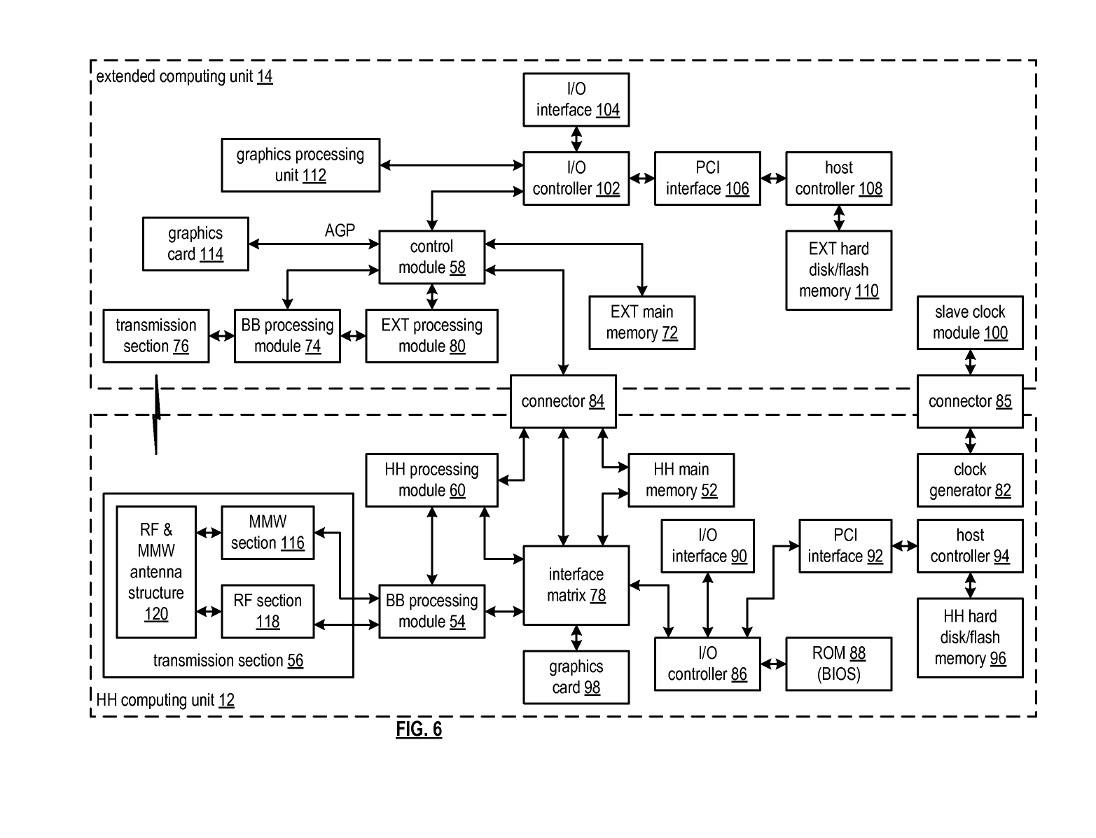

A paging supervisor of the operating system receives the page fault interrupt and, in response, searches for the desired page containing the required virtual address. Once found, the paging supervisor reads the page into main memory and updates the appropriate page table. If there is insufficient room the main memory, the paging supervisor saves an area of the main memory to the HH or EXT hard disk/flash memory (96 and 110 of FIG. 5) and updates the corresponding page table. The cleared area of main memory is then used for the new page.

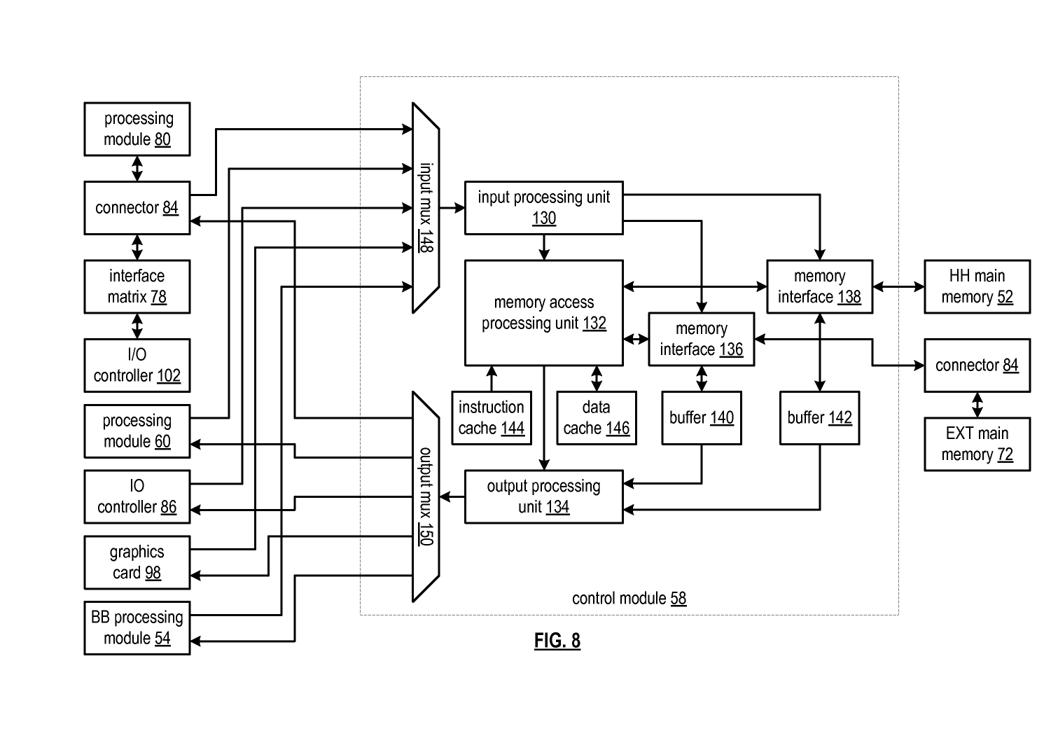

The control module 58 (an embodiment will be discussed in greater detail with reference to FIG. 8) includes a plurality of inputs, a plurality of outputs, and a plurality of memory interfaces. One of the memory interfaces is coupled to the main memory 52 and another one of the memory interfaces is coupled to a connector, which is coupled to the interface matrix 78. The connector is also coupled to one of the inputs and one of the outputs. The processing module 60 is coupled to one of the inputs and to one of the outputs and the baseband processing module 54 is also coupled to one of the inputs and to one of the outputs.

Continuing with the example of operation, the control module 58 controls the flow of data between the main memories 52 and 72, the processing modules 60 and 80, the BB processing modules 54 and 74, and other HH and EXT components. The other HH and EXT components may include a graphics card, a graphics processing unit, an input/output (IO) controller, an IO interface and user interface devices coupled thereto (e.g., mouse, keyboard, printer, CD drive, etc.), a peripheral component interconnect (PCI) interface and components connected thereto (e.g., disk array controller, network card, USB connection, sound card, infrared transceiver, television tuner, video processing, memory expansion, etc.), a host controller, a hard disk and/or flash memory, etc.

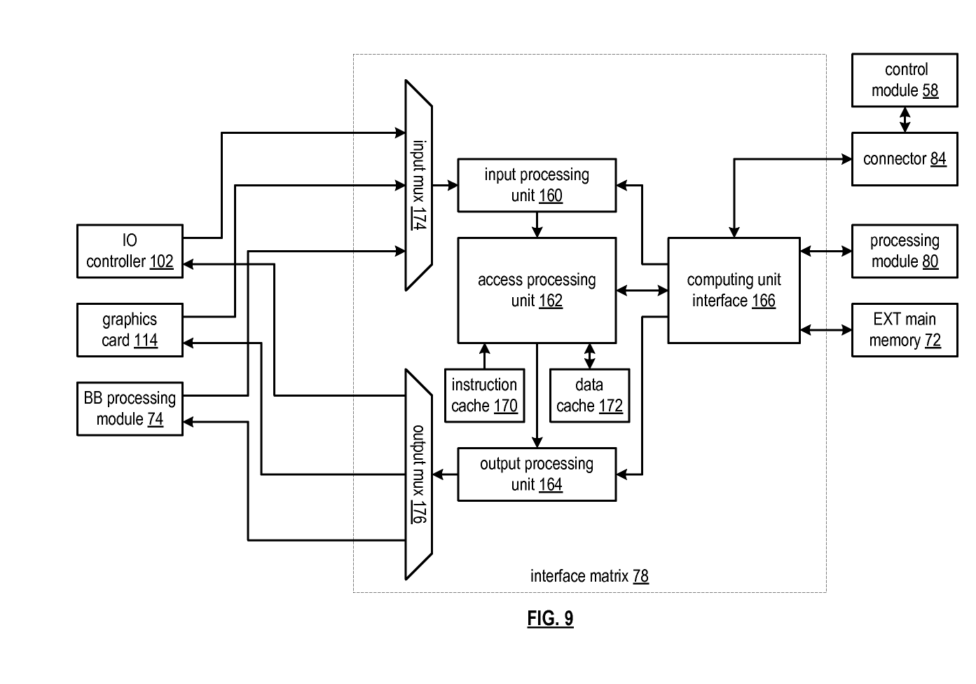

In this example, the control module 58 may transmit or receive data from computing unit 70 via the interface matrix 78 (an embodiment will be discussed in greater detail with reference to FIG. 9) and/or via the BB processing module 54 and the transmission section 56. For example, the control module 58 may use the interface matrix 78, via a wired connection, for data communications between the processing modules 60 and 80, between the main memories 52 and 72, and/or between the processing module of one computing unit 50 or 70 and the main memory of the other computing unit 50 or 70. As another example, the control module 58 may use the BB processing module 54 and transmission section 56 for wirelessly communicating data involving one or more of the other HH and/or EXT components.

As a further example of operation, the control module 58 receives a request via an input (from one of the HH or EXT components, from one of the processing modules, from one of the baseband processing modules, etc.). The control module 58 interprets the request to determine the type of request (e.g., memory access, processing module access, baseband processing module access), the source of the request and the destination of the request. When the request is a memory access request, the control module 58 determines an address from the memory access request. The control module 58 then determines a memory interface of the plurality of memory interfaces based on the address. For instance, when the address corresponds to a physical address within main memory 52, the control module 58 identifies the memory interface coupled to the main memory 52. Having identified the memory interface, the control module 58 transmits a representation of the memory access request to the memory interface.

The representation of the memory access request may be the memory access request itself (e.g., a read request that includes a virtual address or a write request that includes a virtual address and data). Alternatively, the representation may include an interpretation of the memory access request (e.g., a read request that includes a virtual to physical address conversion, a write request with a virtual to physical address conversion, and the data). As another alternative or in furtherance of the previous examples, the representation may include a re-packetization of the memory access request (e.g., add header information, remove header information, change from one packet format to another, etc.). As yet another alternative or in furtherance of the previous examples, the representation may be a signal transformation of the memory access request (e.g., level shift, buffering, driving, etc.) As a further alternative or in furtherance of the previous examples, the representation may be a portion of the memory access request (e.g., the data).

Continuing with the example of operation, the interface matrix 78 facilitates data flow between the computing units 50 and 70 as directed by the control module 58. In an embodiment, the interface matrix 78 includes a plurality of inputs, a plurality of outputs, and a computing unit interface. The computing unit interface is coupled to the processing module 80, to the main memory 72, and to a connector, which is coupled to the control module 58. The other EXT components and the baseband processing module 74 are each coupled to one of the plurality of inputs and to one of the plurality of outputs.

As a further example of operation, the interface matrix 78 receives an input signal via an input of the plurality of inputs (from one of the EXT components, from the processing module 80, from the baseband processing modules, etc.). The interface matrix 78 interprets the input signal to determine the type of signal (e.g., memory access request, processing module access request, baseband processing module access request, etc.), the source of the signal and the destination of the signal, if included. When the input signal is a memory access request, the interface matrix 78 transmits a representation of the memory access request to the computing unit interface. The representation may be as previously described.

Within computing unit 50, the processing module 60, the baseband processing module 54, the transmission section 56, and the control module 58 may be implemented on one or more integrated circuits. For example, they may be implemented on one integrated circuit and the main memory 52 may be implemented via one or more RAM (random access memory) integrated circuits. The RAM may be static RAM (SRAM) and/or dynamic RAM (DRAM). Similarly, within computing unit 70, the processing module 80, the baseband processing module 74, the transmission section 76, and the interface matrix 58 may be implemented on one or more integrated circuits. The main memory 72 may be implemented via one or more RAM integrated circuits.

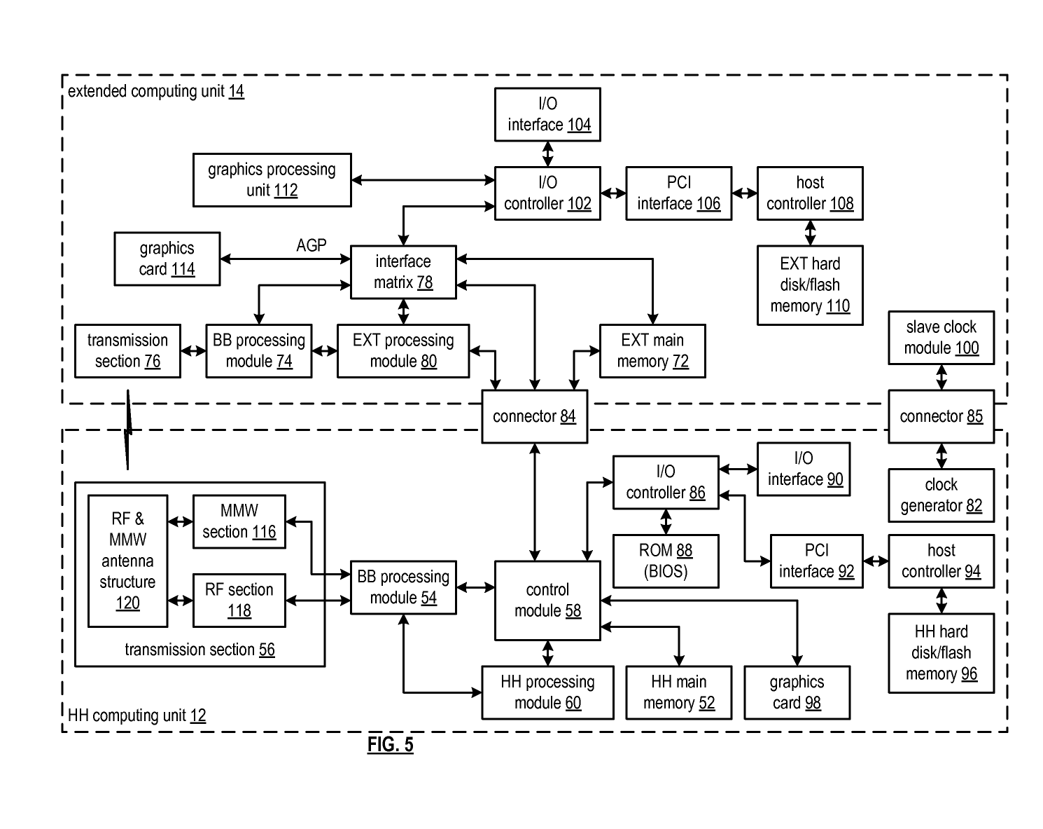

FIG. 4 is a schematic block diagram of another embodiment of a handheld (HH) computing unit 12 docked to an extended (EXT) computing unit 14 to provide a computing device 10. In this embodiment, the computing unit 70 is within the HH computing unit 12 and the computing unit 50 is within the EXT computing unit 14. The computing units 50 and 70 function as previously described with reference to FIG. 3.

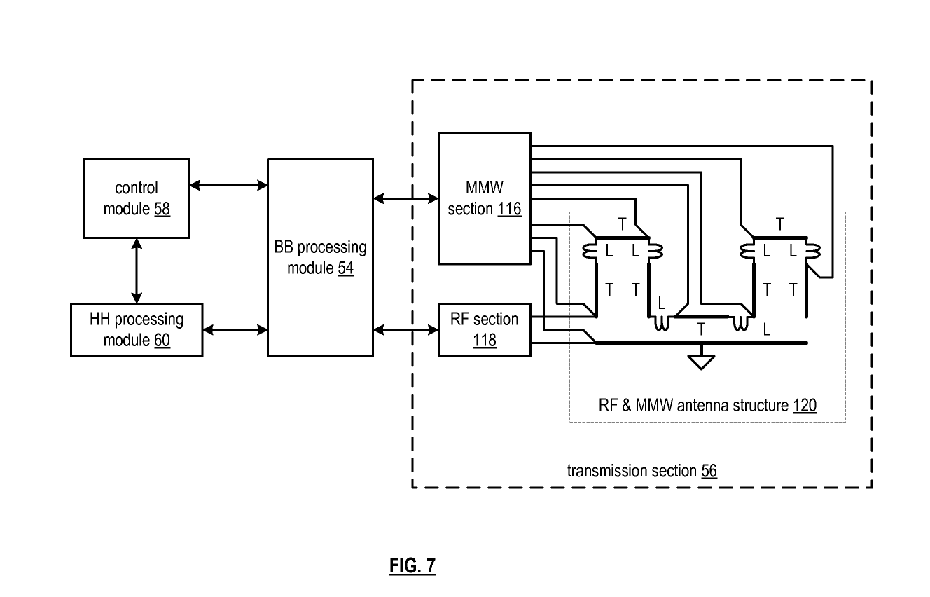

FIG. 5 is a schematic block diagram of another embodiment of a handheld (HH) computing unit 12 docked to an extended (EXT) computing unit 14 to provide a computing device 10. The HH computing unit 12 includes the computing unit 50 (i.e., the control module 58, the HH processing module 60, the HH main memory 52, the baseband (BB) processing module 54, and the transmission section 56), a portion of a connector 84, an input/output (IO) controller 86, a read only memory (ROM) 88, an IO interface 90, a PCI interface 92, a host controller 94, an HH hard disk and/or flash memory 96, a clock generator 82, and a graphics card 98. The transmission section includes a radio frequency (RF) section 118, a millimeter wave (MMW) section 116, and an RF & MMW antenna structure 120. The operation of the BB processing module 54 and the transmission section 56 will be described in greater detail with reference to FIG. 7.

The EXT computing unit 14 includes the computing unit 70 (i.e., the interface matrix 78, the EXT main memory 72, the EXT processing module 80, the EXT BB processing module 74, and the transmission section 76), a graphics card 114, an IO controller 102, an IO interface 104, a PCI interface 106, a host controller 108, an EXT hard disk and/or flash memory 110, and a graphics processing unit 112.

Within the handheld computing unit 12, the handheld hard disk/flash memory 96 may be one or more of a hard disk, a floppy disk, an optical disk, NOR flash memory, NAND flash memory, and/or any other type of non-volatile memory. The clock generator circuit 82 may be one or more of: a phase locked loop, a crystal oscillator circuit, a fractional-N synthesizer, and/or a resonator circuit-amplifier circuit, where the resonator may be a quartz piezo-electric oscillator, a tank circuit, or a resistor-capacitor circuit. Regardless of the implementation of the clock generator circuit 82, it generates a master clock signal that is provided to the slave clock circuit 100 via a wired or wireless connector 85 and generates the clock signals for the handheld computing unit 12. Such clock signals include, but are not limited to, a bus clock, a read/write clock, a processing module clock, a local oscillation, and an I/O clock.

The handheld ROM 88 stores the basic input/output system (BIOS) program for the computing device 10 (i.e., the handheld computing unit 12 and the extended computing unit 14). The ROM 88 may be one or more of an electronically erasable programmable ROM (EEPROM), a programmable ROM (PROM), and/or a flash ROM.

As used herein, an interface includes hardware and/or software for a device coupled thereto to access the bus of the handheld computing unit and/or of the extended computing unit. For example, the interface software may include a driver associated with the device and the hardware may include a signal conversion circuit, a level shifter, etc. Within the handheld computing unit, the I/O interface 90 may include an audio codec, a volume control circuit, a microphone bias circuit, and/or an amplifier circuit coupled to a handheld (HH) microphone and/or to HH speakers 74. The I/O interface 90 may further include a video codec, a graphics engine, a display driver, etc. coupled to an HH display. The I/O interface 90 may also include a display driver, a keypad driver, a touch screen driver, etc. coupled to the HH display and/or the HH keypad.

Within the extended computing unit 14, the EXT hard disk/flash memory 110 may be one or more of a hard disk, a floppy disk, at tape drive, an optical disk, NOR flash memory, NAND flash memory, and/or any other type of non-volatile memory. The slave clock circuit 100 may be a phase locked loop (PLL), clock divider, and/or clock multiplier that receives the master clock signal and produces therefrom the clock signals for the extended computing unit 14. Such clock signals include, but are not limited to, a bus clock, a read/write clock, a processing module clock, and an I/O clock.

The EXT I/O interface 104 may include a sound card and corresponding driver to couple an EXT microphone and/or EXT speakers 100 to the IO controller 102. The I/O interface 104 may further include a video codec, a graphics card, a graphics control unit, a display driver, etc. to couple an EXT display (e.g., monitor 18) to the IO controller 102. The I/O interface 104 may also include a display driver, a keyboard driver, a mouse driver, a touch screen driver, etc. to couple the EXT display and/or an EXT keyboard/mouse to the IO controller 102.

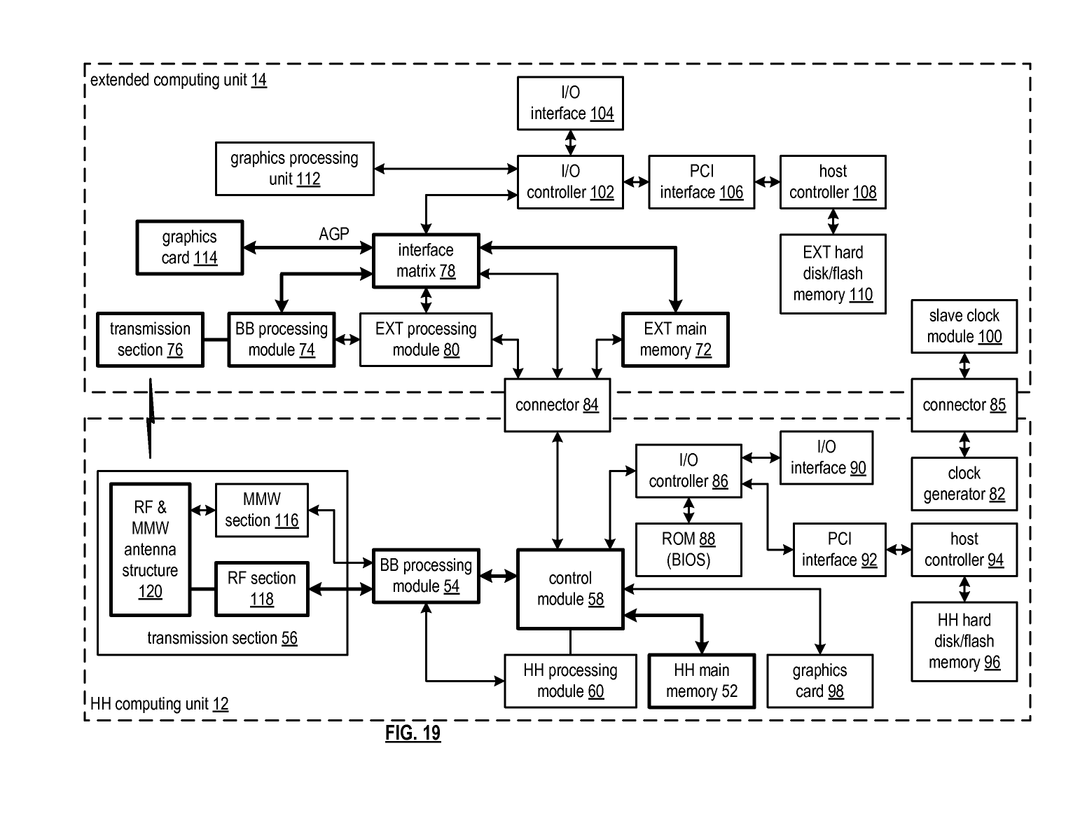

With handheld computing unit 12 docked to the extended computing unit 14, the core components of units 12 and 14 function as a single computing device 10. As such, when the computing device 10 is enabled, the BIOS stored on the HH ROM 88 is executed to boot up the computing device. The BIOS is discussed in greater detail with reference to FIGS. 19-26 of the parent patent applications. After initializing the operating system, which is described in greater detail with reference to FIGS. 19-22 and 27-36 of the parent patent application, the computing device 10 is ready to execute a user application.

In an embodiment, the control module 58 functions as a memory controller to coordinate the reading data from and writing data to the HH main memory 52 and the EXT main memory 72, by the processing modules 60 and 80, by the user I/O devices coupled directly or indirectly to the I/O controllers 86 and 102, by one or more of the graphics cards 98 and 114, and/or for data transfers with the HH and/or EXT hard disk/flash memory 96 and/or 100. Note that if the HH main memory 52 and/or the EXT main memory 72 include DRAM, the control module 58 includes logic circuitry to refresh the DRAM.

I/O controller 102 provides access to the control module 58 via the interface matrix 78 for typically slower devices. For example, the I/O controller 102 provides functionality for the PCI bus via the PCI interface 106; for the I/O interface 104, which may provide the interface for the keyboard, mouse, printer, and/or a removable CD/DVD disk drive; a direct memory access (DMA) controller, interrupt controllers, a host controller 108, which allows direct attached of the EXT hard disk memory 110; a real time clock, an audio interface. The I/O controller 102 may also include support for an Ethernet network card, a Redundant Arrays of Inexpensive Disks (RAID), a USB interface, and/or FireWire. IO controller 86, when in the docked mode, provides a BIOS interface for the ROM 88 access to the control module 58 and provides functionality for the PCI bus via the PCI interface 92, which provides an interface for the host controller 94 and hard disk and/or flash memory 96. In the docked mode, the other IO interfaces (e.g., keyboard, mouse, printer, etc.) may be disabled.

The graphics processing unit (GPU) 112 is a dedicated graphics rendering device for manipulating and displaying computer graphics. In general, the GPU implements a number of graphics primitive operations and computations for rendering two-dimensional and/or three-dimensional computer graphics. Such computations may include texture mapping, rendering polygons, translating vertices, programmable shaders, aliasing, and very high-precision color spaces. The GPU 112 may a separate module on a video card or it may be incorporated into the graphics card 114 that couples to the interface matrix and the control module 58 via an accelerated graphics port (AGP). Note that a video card, or graphics accelerator, functions to generate the output images for the EXT display. In addition, the video card may further include functionality to support video capture, TV tuner adapter, MPEG-2 and MPEG-4 decoding or FireWire, mouse, light pen, joystick connectors, and/or connection to two monitors.

FIG. 6 is a schematic block diagram of another embodiment of a handheld computing unit 12 docked to an extended computing unit 14 to provide a computing device 10. The HH computing unit 12 includes the computing unit 70 (i.e., the interface matrix 78, the HH processing module 60, the HH main memory 52, the baseband (BB) processing module 54, and the transmission section 56), a portion of a connector 84, an input/output (IO) controller 86, a read only memory (ROM) 88, an IO interface 90, a PCI interface 92, a host controller 94, an HH hard disk and/or flash memory 96, a clock generator 82, and a graphics card 98. The transmission section includes a radio frequency (RF) section 118, a millimeter wave (MMW) section 116, and an RF & MMW antenna structure 120.

The EXT computing unit 14 includes the computing unit 50 (i.e., the control module 58, the EXT main memory 72, the EXT processing module 80, the EXT BB processing module 74, and the transmission section 76), a graphics card 114, an IO controller 102, an IO interface 104, a PCI interface 106, a host controller 108, an EXT hard disk and/or flash memory 110, and a graphics processing unit 112.

With handheld computing unit 12 docked to the extended computing unit 14, the core components of units 12 and 14 function as a single computing device 10. As such, when the computing device 10 is enabled, the control module 58, via the connector 84 and the interface matrix 78, retrieves a boot loader from the BIOS stored on the HH ROM 88. The boot loader is executed to retrieve an operating system application from one or more of the hard disk and/or flash memories 96 and/or 110 and store it in one or more of the main memories 52 and/or 72. After initializing the operating system, the computing device 10 is ready to execute a user application.

When the computing device 10 is executing one or more user applications (e.g., word processing, spreadsheet processing, presentation processing, email, web browsing, database, calendar, video games, digital audio playback, digital video playback, digital audio record, digital video record, video games, contact management program, notes, web favorites, money management program, etc.), the HH processing module 60 and the EXT processing module 80 function as a multiprocessing module and the HH and EXT main memories 52 and 72 function as combined main memory. In addition, the HH hard disk/flash memory 96 and the EXT hard disk/flash memory 110 function as a combined hard disk/flash memory.

FIG. 7 is a schematic block diagram of an embodiment of a portion of a handheld computing unit 12 that includes the BB processing module 54, the control module 58, the processing module 60, and the transmission section 56. The transmission section 56 includes the RF section 118, the MMW section 116, and the RF & MMW antenna structure 120. The RF & MMW antenna structure 120 includes a plurality of inductors (L) and a plurality of antenna elements (T).

In an example of operation, the computing device 10 is active to support a cellular telephone. In this state, the processing module 60, the baseband processing module 54 and the RF section 118 are active. For example, the baseband processing module 54 receives an outbound voice signal from the control module 58 or from the processing module 60. The control module 58 may receive the outbound voice signal from the HH IO controller or the EXT IO controller, whichever is active to receive a microphone input, or may retrieve a stored outbound voice signal (e.g., an outgoing message). The processing module 60 may receive the outbound voice signal from the control module 58 and further process the signal (e.g., combine it with another signal, other than PHY layer processing, etc.) and provide the processed signal to the BB processing module 54 as the outbound voice signal.

The baseband processing module 54 converts an outbound voice signal into an outbound voice symbol stream in accordance with one or more existing wireless communication standards, new wireless communication standards, modifications thereof, and/or extensions thereof (e.g., GSM, AMPS, digital AMPS, CDMA, WCDMA, LTE, WiMAX, etc.). The baseband processing module 54 may perform one or more of scrambling, encoding, constellation mapping, modulation, frequency spreading, frequency hopping, beamforming, space-time-block encoding, space-frequency-block encoding, and/or digital baseband to IF conversion to convert the outbound voice signal into the outbound voice symbol stream. Depending on the desired formatting of the outbound voice symbol stream, the baseband processing module 54 may generate the outbound voice symbol stream as Cartesian coordinates (e.g., having an in-phase signal component and a quadrature signal component to represent a symbol), as Polar coordinates (e.g., having a phase component and an amplitude component to represent a symbol), or as hybrid coordinates as disclosed in co-pending patent application entitled HYBRID RADIO FREQUENCY TRANSMITTER, having a filing date of Mar. 24, 2006, and an application Ser. No. 11/388,822, and co-pending patent application entitled PROGRAMMABLE HYBRID TRANSMITTER, having a filing date of Jul. 26, 2006, and an application Ser. No. 11/494,682.

The RF section 118 converts the outbound voice symbol stream into an outbound RF voice signal in accordance with the one or more existing wireless communication standards, new wireless communication standards, modifications thereof, and/or extensions thereof (e.g., GSM, AMPS, digital AMPS, CDMA, WCDMA, LTE, WiMAX, etc.). In one embodiment, the RF section 118 receives the outbound voice symbol stream as Cartesian coordinates. In this embodiment, the RF section 118 mixes the in-phase components of the outbound voice symbol stream with an in-phase local oscillation to produce a first mixed signal and mixes the quadrature components of the outbound voice symbol stream to produce a second mixed signal. The RF section 118 combines the first and second mixed signals to produce an up-converted voice signal. The RF section 118 then amplifies the up-converted voice signal to produce the outbound RF voice signal, which it provides to an antenna section. Note that further power amplification may occur between the output of the RF section 18 and the input of the antenna structure 120.

In one or more other embodiments, the RF section 118 receives the outbound voice symbol stream as Polar or hybrid coordinates. In these embodiments, the RF section 118 modulates a local oscillator based on phase information of the outbound voice symbol stream to produce a phase modulated RF signal. The RF section 118 then amplifies the phase modulated RF signal in accordance with amplitude information of the outbound voice symbol stream to produce the outbound RF voice signal. Alternatively, the RF section 118 may amplify the phase modulated RF signal in accordance with a power level setting to produce the outbound RF voice signal.

The RF section 118 provides the outbound RF voice signal to the antenna structure 120, which includes the plurality of inductors (L) and a plurality of antenna segments (T). In an embodiment, the inductors (L) have an inductance that provides a low impedance at the carrier frequency of the outbound RF voice signal (e.g., 900 MHz, 1800 MHz, 1900 MHz, etc.) and provides a high impedance at the carrier frequency of a MMW signal (e.g., 60 GHz). For example, 17.9 nano-Henries provides an impedance of approximately 1 Ohm at 900 MHz and provides an impedance of approximately 6.75 K-Ohm at 60 GHz.

Each antenna segment (T), which may be a metal trace on a printed circuit board and/or on an integrated circuit, has a length corresponding to ¼ wavelength, ½ wavelength, or other numerical relationship to the wavelength of the MMW signal. For example, if the MMW signal has a carrier frequency of 60 GHz, then a length of an antenna segment would be 0.25 millimeters for a ½ wavelength segment and 0.125 for a quarter wavelength segment. The total number of segments (T) used for transmitting the outbound RF voice signal depends on the carrier frequency of the RF signal to achieve the desired length of the antenna. In this example, the resulting RF antenna is shown as a meandering trace that includes a plurality of segments (T) coupled via a plurality of inductors (L), but other antenna shapes may be used.

For incoming voice signals, the RF section 118 receives an inbound RF voice signal via the antenna section 120. The RF section 118 converts the inbound RF voice signal into an inbound voice symbol stream. In an embodiment, the RF section 118 extracts Cartesian coordinates from the inbound RF voice signal to produce the inbound voice symbol stream. In another embodiment, the RF section 118 extracts Polar coordinates from the inbound RF voice signal to produce the inbound voice symbol stream. In yet another embodiment, the RF section 118 extracts hybrid coordinates from the inbound RF voice signal to produce the inbound voice symbol stream.

The baseband processing module 54 converts the inbound voice symbol stream into an inbound voice signal. The baseband processing module 54 may perform one or more of descrambling, decoding, constellation demapping, modulation, frequency spreading decoding, frequency hopping decoding, beamforming decoding, space-time-block decoding, space-frequency-block decoding, and/or IF to digital baseband conversion to convert the inbound voice symbol stream into the inbound voice signal.

The baseband processing module 54 and the RF section 118 function similarly for transceiving data communications (e.g., GPRS, EDGE, HSUPA, HSDPA, etc.) and for processing WLAN communications. For data communications, the baseband processing module 54 and the RF section 118 function in accordance with one or more cellular data protocols such as, but not limited to, Enhanced Data rates for GSM Evolution (EDGE), General Packet Radio Service (GPRS), high-speed downlink packet access (HSDPA), high-speed uplink packet access (HSUPA), newer version thereof, and/or replacements thereof. For WLAN communications, the baseband processing module 54 and the RF section 118 function in accordance with one or more wireless communication protocols such as, but not limited to, IEEE 802.11(a), (b), (g), (n), etc., Bluetooth, ZigBee, RFID, etc.

In another example of operation, the computing device 10 is active to support MMW communications between the HH computing unit 12 and the EXT computing 14. In this state, the processing module 60, the baseband processing module 54 and the RF section 118 are active. For example, the baseband processing module 54 receives an outbound signal from the control module 58 or from the processing module 60. The control module 58 may receive the outbound signal from the HH IO controller or the HH main memory 52. The outbound signal may be a memory access request, a memory response, an interrupt request, a processing module access request, a processing module response, or other data signal. The processing module 60 may receive the outbound signal from the control module 58 and further process the signal (e.g., combine it with another signal, generate a response, other than PHY layer processing, etc.) and provide the processed signal to the BB processing module 54 as the outbound signal.

The baseband processing module 54 converts an outbound signal into an outbound symbol stream in accordance with one or more existing wireless communication standards, new wireless communication standards, modifications thereof, and/or extensions thereof. The baseband processing module 54 may perform one or more of scrambling, encoding, constellation mapping, modulation, frequency spreading, frequency hopping, beamforming, space-time-block encoding, space-frequency-block encoding, and/or digital baseband to IF conversion to convert the outbound signal into the outbound symbol stream. Depending on the desired formatting of the outbound symbol stream, the baseband processing module 54 may generate the outbound symbol stream as Cartesian coordinates (e.g., having an in-phase signal component and a quadrature signal component to represent a symbol), as Polar coordinates (e.g., having a phase component and an amplitude component to represent a symbol), or as hybrid coordinates.

The MMW section 116 converts the outbound symbol stream into an outbound MMW signal in accordance with the one or more existing wireless communication standards, new wireless communication standards, modifications thereof, and/or extensions thereof. In one embodiment, the MMW section 116 receives the outbound symbol stream as Cartesian coordinates. In this embodiment, the MMW section 116 mixes the in-phase components of the outbound symbol stream with an in-phase local oscillation to produce a first mixed signal and mixes the quadrature components of the outbound symbol stream to produce a second mixed signal. The MMW section 116 combines the first and second mixed signals to produce an up-converted signal. The MMW section 116 then amplifies the up-converted signal to produce the outbound MMW signal, which it provides to an antenna structure 120. Note that further power amplification may occur between the output of the MMW section 116 and the input of the antenna structure 120.

In one or more other embodiments, the MMW section 116 receives the outbound symbol stream as Polar or hybrid coordinates. In these embodiments, the MMW section 116 modulates a local oscillator based on phase information of the outbound voice symbol stream to produce a phase modulated MMW signal. The MMW section 116 then amplifies the phase modulated MMW signal in accordance with amplitude information of the outbound symbol stream to produce the outbound MMW signal. Alternatively, the MMW section 116 may amplify the phase modulated MMW signal in accordance with a power level setting to produce the outbound MMW signal.

The MMW section 116 provides the outbound MMW signal to the antenna structure 120, which includes the plurality of inductors (L) and a plurality of antenna segments (T). For MMW signals, the antenna segments (T) function as independent antennas due to the impedance of the inductors (L) at the carrier frequency of the MMW signal (e.g., 60 GHz). As such, the MMW section 116 may provide the outbound MMW signal to one or more of the antenna segments (T) for MIMO communications, MISO communications, beamforming, etc.

For incoming MMW signals, the MMW section 116 receives an inbound MMW signal via the antenna section 120. The MMW section 116 converts the inbound MMW signal into an inbound symbol stream. In an embodiment, the MMW section 116 extracts Cartesian coordinates from the inbound MMW signal to produce the inbound symbol stream. In another embodiment, the MMW section 116 extracts Polar coordinates from the inbound MMW signal to produce the inbound symbol stream. In yet another embodiment, the MMW section 116 extracts hybrid coordinates from the inbound MMW signal to produce the inbound symbol stream.

The baseband processing module 54 converts the inbound symbol stream into an inbound signal. The baseband processing module 54 may perform one or more of descrambling, decoding, constellation demapping, modulation, frequency spreading decoding, frequency hopping decoding, beamforming decoding, space-time-block decoding, space-frequency-block decoding, and/or IF to digital baseband conversion to convert the inbound symbol stream into the inbound signal.

FIG. 8 is a schematic block diagram of an embodiment of a control module 58 coupled to handheld and/or extended computing unit components. The control module 58 includes a plurality of inputs (e.g., inputs of the input multiplexer 148), a plurality of outputs (e.g., outputs of the output multiplexer 150), a plurality of memory interfaces 136-138, a plurality of buffers 140-142, an input processing unit 130, a memory access processing unit 132, an output processing unit 134, an instruction cache 144, and a data cache 146.

In general, the input processing unit 130, the memory access processing unit 132, and the output processing unit 134 function concurrently on different requests to create a request pipeline. The input processing unit 130, the memory access processing unit 132, and the output processing unit 134 may be the same or different processing units. Such a processing unit may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions.

In an example of operation, the input mux 148 receives a memory access request (e.g., a read request or a write request), a processing module request (e.g., requesting a co-processing function or a multiple-processing operation), and/or a baseband processing module request (e.g., transmit or receive data or instructions wirelessly via the baseband processing module and the transmission section) from one the components coupled thereto. The components include HH components and EXT components. The HH components include the processing module 60, the IO controller 86, the components coupled to the IO controller 86 (e.g., the IO interface 90, the PCI interface 92, the ROM 88, and any further components coupled to the IO interface 90 and/or to the PCI interface 92), the graphics card 98, and the baseband processing module 54 and the EXT components include the processing module 80, the IO controller 102, the components coupled to the IO controller 102 (e.g., the IO interface 104, the PCI interface 106, the graphics processing unit 112, the graphics card 114, and any further components coupled to the IO interface 104 and/or to the PCI interface 106).

The input processing unit 130 schedules the requests for processing by the memory access processing unit 132. In addition, the input processing unit 130 may initialize the memory access processing unit 130 based on the address space of a memory access request and whether the request is a read request or a write request.

The memory access processing unit 132 executes a protocol handler for each memory access request. In particular, the memory access processing unit 132 checks and updates directory entries to preserve cache coherency and to facilitate the performance of active memory data operations. The active memory data operations include address remapping (e.g., virtual to physical address conversion), cache line stores and/or loads to/from the main memories via the memory interfaces 136-138, and reply messages (e.g., cache coherence error). The buffers 140-142 may be used to facilitate the pipeline timing; the instruction cache 144 includes instructions of the protocol handlers; and the data cache 146 stores intermediate data.

For a read request, the output processing unit 134 receives one or more cache lines of retrieved data, attaches a header thereto, and places it in a queue. The queue provides the retrieved data to the output mux 150, which provides it, via one of its outputs, to the requesting component. In addition, the output processing unit 134 provides any reply messages generated by the memory access processing unit 130.

For a processing module request, the input processing unit 130 schedules the request for the memory access processing module 132. The memory access processing module 132 processes the request, determines that it is a processing module request, and provides the request and the routing address of the processing module 60 to the output processing unit 134. The output processing unit 134 queues the request for subsequent outputting by the output mux 150 to the processing module 60.

For a baseband processing module request, the input processing unit 130 schedules the request for the memory access processing module 132. The memory access processing module 132 processes the request, determines that it is a baseband processing module request, and provides the request and the routing address of the baseband processing module 60 to the output processing unit 134. The output processing unit 134 queues the request for subsequent outputting by the output mux 150 to the baseband processing module 54.

FIG. 9 is a schematic block diagram of an embodiment of an interface matrix 78 coupled to handheld and/or extended computing unit components. The interface matrix 78 includes an input mux 174, an input processing unit 160, an access processing unit 162, a computing unit interface 166, an output processing unit 164, an output mux 176, an instruction cache 170, and a data cache 172.

The input processing unit 160, the access processing unit 162, and the output processing unit 164 may be the same or different processing units. Such a processing unit may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions.

In an example of operation, the input processing unit 160 receives an input signal from the input mux 174 and/or from the computing unit interface 166. Input signals received via the input mux 174 are from one of the EXT components coupled thereto; such as the graphics card 114, the baseband processing module 74, the IO controller 102, and/or the components coupled to the IO controller 102 (e.g., the IO interface 104, the PCI interface 106, the graphics processing unit 112, and any further components coupled to the IO interface 104 and/or to the PCI interface 106). Input signals received via the computing unit interface 166 are from the processing module 80 or the control module 58, via the connector 84. Note that the input signals may be memory access requests, processing module requests, baseband processing module requests, or responses to a request.

The input processing unit 160 schedules the input signals for processing by the access processing unit 162. The access processing unit 162 executes a program to determine whether the input signal is to be routed to the computing unit interface 166 or to the output processing unit 164. In this instance, the access processing unit 162 interprets the input signal to determine its source, its destination, and/or the content of the payload (e.g., a memory access request, a processing module request, a baseband processing module request, a response to a request, etc.). The access processing unit 162 routes the input signal to the computing unit 166 or to the output processing unit 164 based on the interpretation. Note that the computing unit interface 166 may be a controlled switching network that, based on a control signal from the access processing unit 162 or the control module 58, routes a request or response to the appropriate component.

The output processing unit 164 queues the output signals (e.g., signals received from the access processing unit 162 and/or from the computing unit interface 166). The queued output signals are subsequently provided to one of the EXT components via the output mux 176.

For example, if the IO controller 102 receives a data input via a user interface (e.g., a keyboard) coupled to the IO interface 104, the IO controller 102 provides the data input to the input mux 174 as the input signal. The input data may be a command regarding a currently executing user application, a data entry of a currently executing user application, a request to open a user application, a request to close a user application, etc. The input processing unit 160 schedules the input data for processing by the access processing unit in accordance with a scheduling protocol.

The access processing unit 162 interprets the input data to determine that it is related to a user application being executed by the processing module 60. In this instance, the access processing unit 162 forwards the input data to the computing unit interface 166 and provides a control signal indicating that the input data is to be forwarded to the control module 58 via the connector 84.

As another example, the graphics card 114 is coupled to a monitor, a projector, etc. for displaying user application data and/or other data. The data may be stored in the EXT main memory 72 and/or in the HH main memory 52. The control module 58 controls the flow of the display data from the main memories to the graphics card 114 via the interface matrix 78. The control module 58 controls the flow of data from the EXT main memory 72 via the computing unit interface 166, the output processing unit 164, and the output mux 176. The control module 58 may provide display data from the HH main memory 52 via the connector 84 and/or via the wireless connection that includes the baseband processing module 74. For display data provided via the connector, the data flows via the computing unit interface 166, the output processing unit 164, and the output mux 176.

For display data provided by the wireless connection, the baseband processing module receives the display data as an inbound data stream. The baseband processing module 74 converts the inbound data stream into inbound data, which is the display data. The baseband processing module 74 provides the display data to the input mux 174, which is subsequently processed by the access processing unit 162. In this instance, the access processing unit 162 determines that the display data is for the graphics card 114 and thus routes it to the output processing unit 164.

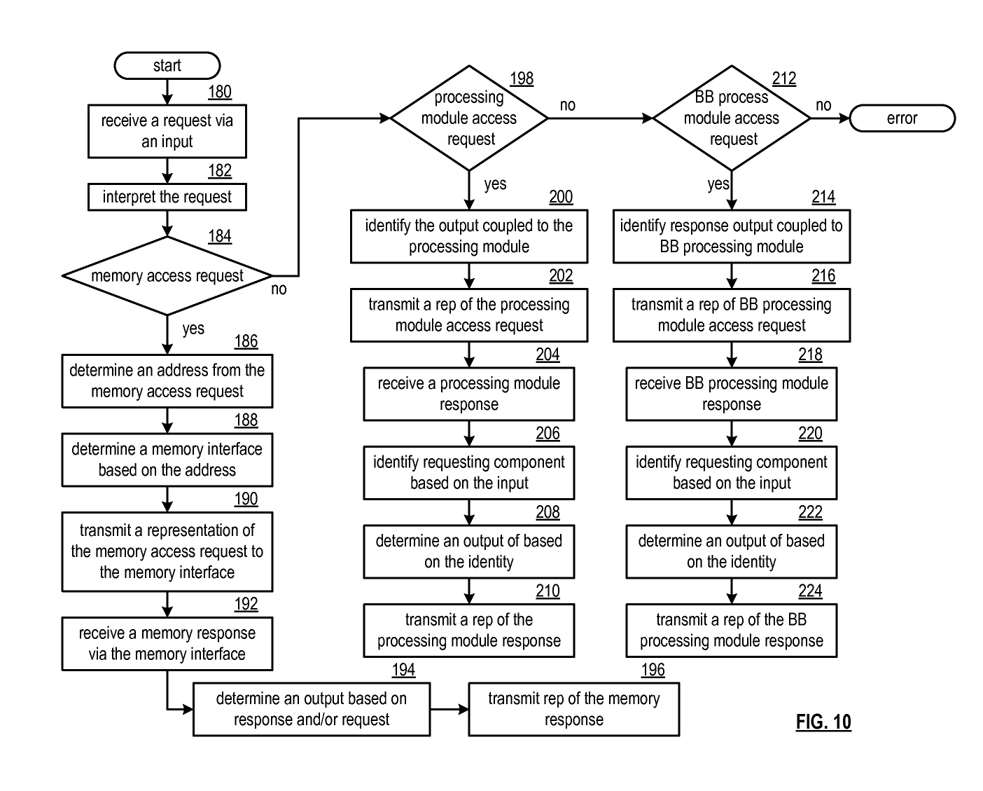

FIG. 10 is a logic diagram of an embodiment of a control module method that begins at step 180 where the control module 58 receives a request via an input of the plurality of inputs (e.g., an input of the input mux 148). The method continues at step 182 where the control module interprets the request. For example, the control module 58 interprets the request by determining a source, a destination, and content of the request (e.g., a memory access request, processing module access request [e.g., an interrupt, co-processing, multiprocessing, etc], a baseband processing module access request [e.g., a request to transmit or receive data via the transmission section]).

The method continues at step 184 where the control module 58 determines whether the request is a memory access request. When the request is a memory access request, the method continues at step 186 where the control module determines an address from the memory access request. The method continues at step 188 where the control module determines a memory interface of the plurality of memory interfaces based on the address. For example, the control module 58 determines a cache line, page, block, etc. of data based on the address. The control module then determines which main memory is storing the data. Having identified the main memory, the control module 58 determines the memory interface based on a mapping of memory interfaces to main memories.

If the data identified by the address is not in main memory when the memory access request is received, the control module 58 determines which hard disk/flash memory is storing the data. Once identified, the control module 58 sends a retrieve data message via the output processing unit and the output mux to the HH IO controller 86 or the EXT IO controller 102. The HH IO controller 86 or the EXT IO controller 102 receives the retrieved data from its corresponding hard disk/flash memory and provides the data to the control module. The control module 58 coordinates the storage of the retrieved data in the appropriate main memory.

The method continues at step 190 where the control module transmits a representation of the memory access request to the memory interface. The representation of the memory access request may be the memory access request itself (e.g., a read request that includes a virtual address or a write request that includes a virtual address and data). Alternatively, the representation may include an interpretation of the memory access request (e.g., a read request that includes a virtual to physical address conversion, a write request with a virtual to physical address conversion, and the data). As another alternative or in furtherance of the previous examples, the representation may include a re-packetization of the memory access request (e.g., add header information, remove header information, change from one packet format to another, etc.). As yet another alternative or in furtherance of the previous examples, the representation may be a signal transformation of the memory access request (e.g., level shift, buffering, driving, etc.) As a further alternative or in furtherance of the previous examples, the representation may be a portion of the memory access request (e.g., the data).

The memory interface forwards the representation of the memory access request to the appropriate main memory. The method continues at step 192 where the control module 59 receives a memory response via the memory interface. The memory response is data for a read request and may be a confirmation for a write request. The method continues at step 194 where the control module 58 determines an output of the plurality of outputs (e.g., one of the outputs of the output mux 150) based on the memory response and/or the memory access request. For example, if the memory access request is a read request, then the destination of the requested data is the source of the request. If, however, the request was a write request as part of executing a program, the destination of the response may be different than the write request.

The method continues at step 196 where the control module 58 transmits a representation of the memory response to the output. The representation of the memory response may be the memory response itself (e.g., a read data, an acknowledgment, an error message, etc.). Alternatively, the representation may include an interpretation of the memory response (e.g., includes a physical to virtual address conversion). As another alternative or in furtherance of the previous examples, the representation may include a re-packetization of the memory response (e.g., add header information, remove header information, change from one packet format to another, etc.). As yet another alternative or in furtherance of the previous examples, the representation may be a signal transformation of the memory response (e.g., level shift, buffering, driving, etc.). As a further alternative or in furtherance of the previous examples, the representation may be a portion of the memory response (e.g., the data).

If, at step 184, the request is not a memory access request, the method continues at step 198 where the control module 58 determines whether the request is a processing module access request (e.g., an interrupt request, co-processing request, multiprocessing function, user application process, system application process, etc.). If yes, the method continues at step 200 where the control module 58 identifies the output coupled to the processing module. This may be done based on a mapping of outputs to HH and/or EXT components.

The method continues at step 202 where the control module 58 transmits a representation of the processing module access request to the output. The representation of the processing module access request may be the processing module access request itself. Alternatively, the representation may include an interpretation of the processing module access request. As another alternative or in furtherance of the previous examples, the representation may include a re-packetization of the processing module access request. As yet another alternative or in furtherance of the previous examples, the representation may be a signal transformation of the processing module access request. As a further alternative or in furtherance of the previous examples, the representation may be a portion of the processing module access request (e.g., an abbreviated command set).

The method continues at step 204 where the control module 58 receives a processing module response (e.g., results of the co-processing task, results of the multiprocessing task, results of the interrupt, request for further information, intermediate results for the co-processing task, the multiprocessing task, and/or the interrupt) via the input coupled to the processing module. The method continues at step 206 where the control module 58 identifies a requesting component based on the input from which the processing module access request was received. The method continues at step 208 where the control module 58 determines an output based on the identity of the requesting component. The method continues at step 210 where the control module transmits a representation of the processing module response to the output.

If, at step 198, the request is not a processing module access request, the method continues at step 212 where the control module determines whether the request is a baseband processing module access request. If not, the request is invalid. If, however, the request is a baseband processing module access request (e.g., a request to wirelessly transmit or receive data, instructions, etc. between the HH unit and the EXT unit), the method continues at step 214 where the control module 58 identifies the output coupled to the baseband processing module. The method continues at step 216 where the control module 58 transmits a representation of the baseband processing module access request to the output. The method continues at step 218 where the control module receives a baseband processing module response (e.g., received inbound data) via the input coupled to the baseband processing module.

The method continues at step 220 where the control module 58 identifies a requesting component based on the input from which the baseband processing module access request was received. The method continues at step 222 where the control module determines an output based on the identity of the requesting component. The method continues at step 224 where the control module transmits a representation of the baseband processing module response to the output.

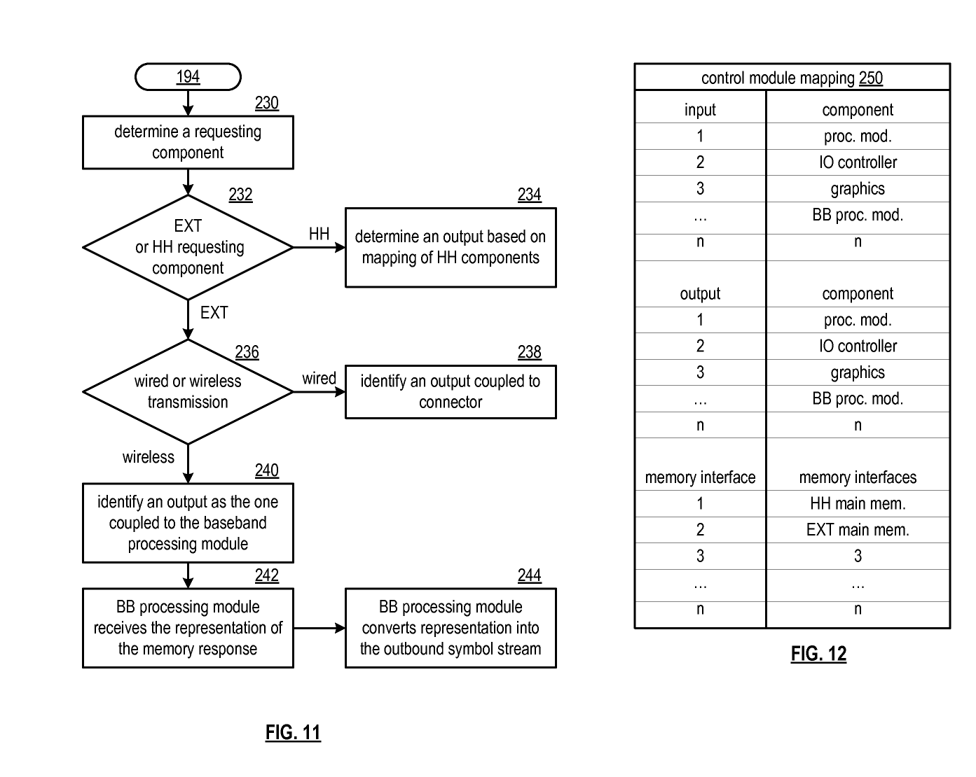

FIG. 11 is a logic diagram of a further embodiment of step 194 of FIG. 10 that is based on the control module 58 being in the HH computing unit 12. This further embodiment method begins at step 230 where the control module 58 interprets the memory response and/or the memory access request to determine a requesting component. The method continues at step 232 where the control module 58 determines whether the requesting component is a handheld computing unit component or an extended computing unit component. This may be done by accessing a mapping of handheld computing unit components and extended computing unit components operably coupled to the control module. The mapping may be created during the loading of an operating system for a docked mode of operation.

For example, FIG. 12 illustrates a control module mapping of inputs to components, of outputs to components, and of memory interfaces to main memories. As shown in this example, the 1st input and 1st output are mapped to the local processing module (e.g., processing module 60 if the control module 58 is within the HH computing unit 12 or processing module 80 if the control module 58 is within the EXT computing unit 14). As is further shown, the 2nd input and 2nd output are mapped to the local IO controller (e.g., 86 or 102); the 3rd input and 3rd output are mapped to the local graphics card, etc. While not shown in this example, one of the inputs and one of the outputs are mapped to the connector 84.

As is further shown in the example of FIG. 12, the 1st memory interface is coupled to the handheld main memory 52 and the second memory interface is coupled to the extended main memory 72 via the connector. If the units 12 and 14 include multiple main memories, then the other memory interfaces would be mapped to the additional main memories.

Returning to the logic diagram of FIG. 11, if, at step 232, the requesting component is a handheld component, the method continues at step 234 where the control module determines an output for the HH component based on the mapping. If, at step 232, the requesting component is an EXT component, the method continues at step 236 where the control module 58 determines whether to communicate (e.g., transmit the memory response) with the EXT component via a wired communication path (e.g., via the connector 84) or a wireless communication path (e.g., via the baseband processing modules and the corresponding transmission sections). The determination of which path to use may be based on availability of the wireless communication path, availability of the wired communication path, amount of data contained in the memory response, a predetermined setting, error rate of the wireless communication path, bandwidth of the wireless communication path, bandwidth of the wired communication path, and/or sensitivity of the data contained in the memory response.

When the wired path is used, the method continues at step 238 where the control module 58 identifies the output coupled to the connector based on the mapping. When the wireless path is used, the method continues at step 240 where the control module 58 identifies the output coupled to the baseband processing module based on the mapping. The method continues at step 242 where the baseband processing module receives the representation of the memory response, which includes an identification code of the requesting component. The method continues at step 244 where the baseband processing module converts the representation of the memory response into the outbound symbol stream.

The method of FIG. 11 is applicable to the control module 58 being in the EXT computing unit 14 with the decision of step 232 being reversed. For instance, with the control module 58 in the EXT unit 14, if the requesting component is an EXT component, the method continues at step 234 where the control module identifies the output based on the mapping of the EXT component to the output. If the requesting component is an HH component, the method continues at step 236.

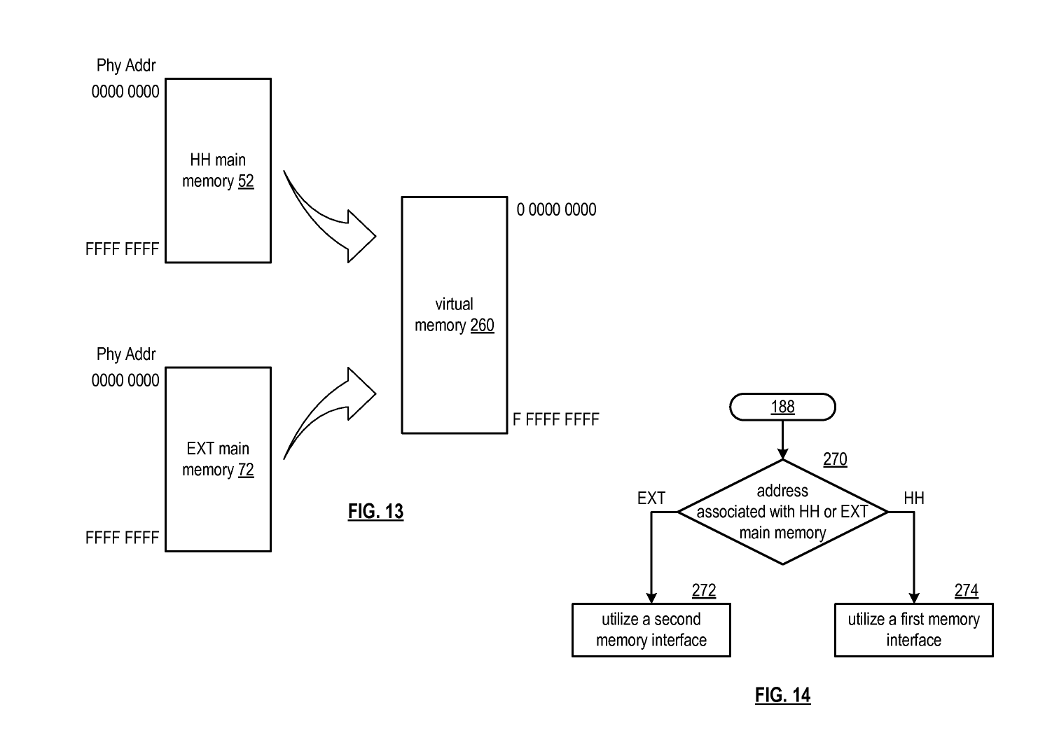

FIG. 13 is a diagram of an example of memory mapping the physical addresses of the main memories 52 and 72 to a virtual main memory 260. In this example, each of the main memories 52 and 72 are approximately 4 Giga-byte (GB) RAMs (e.g., 16⁸). The virtual main memory 260 includes approximately 64 Giga-bytes of space (e.g., 16⁹). In this example, the physical memory of main memory 52 is mapped to a 4 GB space in the virtual memory 260, which may be a contiguous memory space or non-contiguous. The physical memory of the main memory 72 is mapped to another 4 GB space in the virtual memory 260.

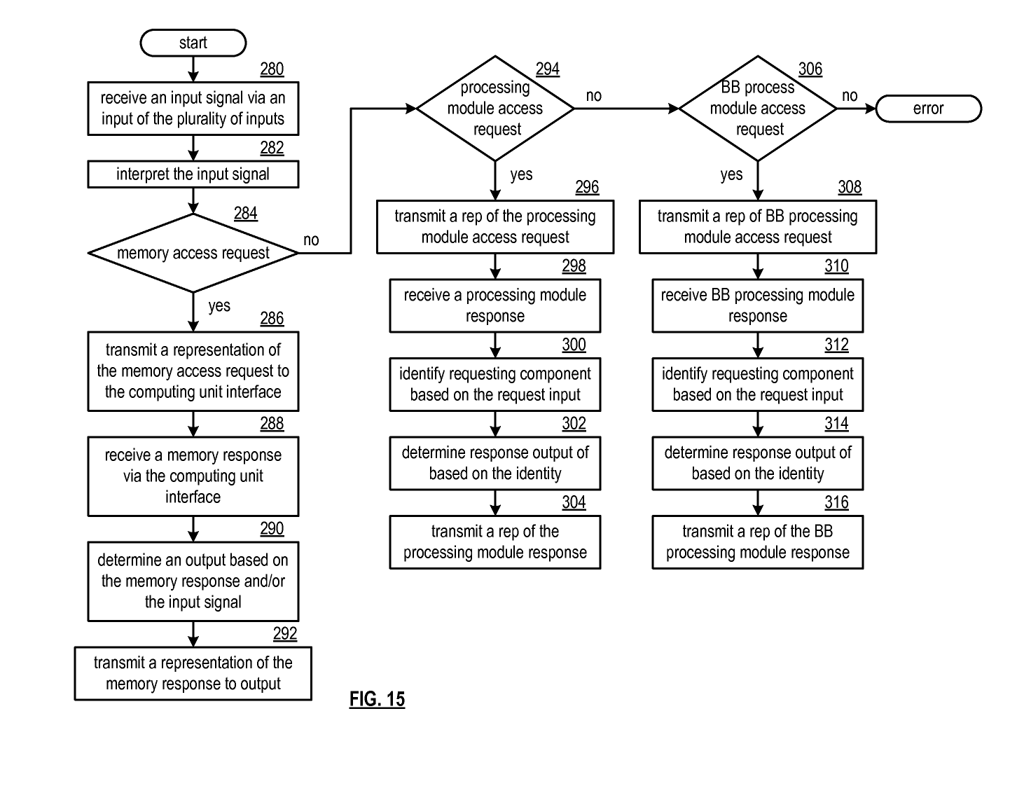

FIG. 14 is a logic diagram of a further embodiment of step 188 of FIG. 10 that is based on the control module 58 being in the HH computing unit 12. This further embodiment method begins at step 270 where the control module 58 determines whether the address is associated with the HH main memory 52 or the EXT main memory 72. If the address is a virtual address, the control module determines the virtual memory space being addressed and identifies the main memory associated with the addressed virtual memory space. If the address is associated with the HH main memory, the method continues at step 274 where the control module 58 uses a first memory interface. If the address is associated with the EXT main memory, the method continues at step 272 where the control module uses a second memory interface.

FIG. 15 is a logic diagram of an embodiment of an interface module method that begins at step 280 where the interface matrix 78 receives an input signal via an input of the plurality of inputs (e.g., an input of the input mux 174). The method continues at step 282 where the interface matrix 78 interprets the input signal. For example, the interface matrix 78 interprets the request by determining a source, a destination, and any accompanying command by the control module (e.g., forward input signal to processing module 80, send to the IO controller, send to the computing unit interface, memory access request, processing module access request, baseband processing module access request, etc.).

The method continues at step 284 where the interface matrix 78 determines whether the request is a memory access request. When the request is a memory access request, the method continues at step 286 where the interface matrix 78 transmits a representation of the memory access request to the computing unit interface for forwarding to the control module 58, which will process the memory access request. The representation of the memory access request may be the processing module access request itself. As alternative or in furtherance of the previous examples, the representation may include a re-packetization of the memory access request. As yet another alternative or in furtherance of the previous examples, the representation may be a signal transformation of the memory access request.

The method continues at step 288 where the interface matrix 78 receives a memory response via the memory interface. The memory response is data for a read request and may be a confirmation for a write request. The method continues at step 290 where the interface matrix 78 determines an output of the plurality of outputs (e.g., one of the outputs of the output mux 176) based on the memory response and/or the memory access request. For example, if the memory access request is a read request, then the destination of the requested data is the source of the request. If, however, the request was a write request as part of executing a program, the destination of the response may be different than the write request.

The method continues at step 292 where the interface matrix 78 transmits a representation of the memory response to the output. The representation of the memory response may be the memory response itself (e.g., a read data, an acknowledgment, an error message, etc.). As an alternative or in furtherance of the previous example, the representation may include a re-packetization of the memory response (e.g., add header information, remove header information, change from one packet format to another, etc.). As yet another alternative or in furtherance of the previous examples, the representation may be a signal transformation of the memory response (e.g., level shift, buffering, driving, etc.). As a further alternative or in furtherance of the previous examples, the representation may be a portion of the memory response (e.g., the data).

If, at step 284, the request is not a memory access request, the method continues at step 294 where the interface matrix 78 determines whether the request is a processing module access request (e.g., an interrupt request, co-processing request, multiprocessing function, user application process, system application process, etc.). If yes, the method continues at step 296 where the interface matrix 78 transmits a representation of the processing module access request to the computing unit interface 166. The representation of the processing module access request may be the processing module access request itself. Alternatively, the representation may include an interpretation of the processing module access request. As another alternative or in furtherance of the previous examples, the representation may include a re-packetization of the processing module access request. As yet another alternative or in furtherance of the previous examples, the representation may be a signal transformation of the processing module access request. As a further alternative or in furtherance of the previous examples, the representation may be a portion of the processing module access request (e.g., an abbreviated command set).

The method continues at step 298 where the interface matrix 78 receives a processing module response (e.g., results of the co-processing task, results of the multiprocessing task, results of the interrupt, request for further information, intermediate results for the co-processing task, the multiprocessing task, and/or the interrupt) via the computing unit interface 166. The method continues at step 300 where the interface matrix 78 identifies a requesting component based on the input from which the processing module access request was received. The method continues at step 302 where the interface matrix 78 determines an output based on the identity of the requesting component. The method continues at step 304 where the interface matrix 78 transmits a representation of the processing module response to the output.

If, at step 294, the request is not a processing module access request, the method continues at step 306 where the control module determines whether the request is a baseband processing module access request. If not, the request is invalid. If, however, the request is a baseband processing module access request (e.g., a request to wirelessly transmit or receive data, instructions, etc. between the HH unit and the EXT unit), the method continues at step 308 where the interface matrix 78 transmits a representation of the baseband processing module access request to the output associated with the baseband processing module. The method continues at step 310 where the interface matrix 78 receives a baseband processing module response (e.g., received inbound data) via the input coupled to the baseband processing module.

The method continues at step 312 where the interface matrix 78 identifies a requesting component based on the input from which the baseband processing module access request was received. The method continues at step 314 where the interface matrix 78 determines an output based on the identity of the requesting component. The method continues at step 316 where the interface matrix 78 transmits a representation of the baseband processing module response to the output.

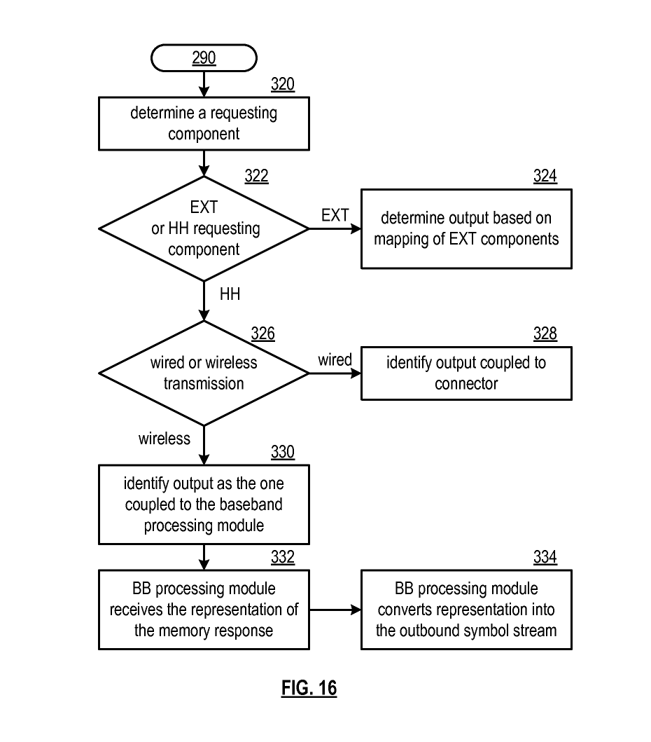

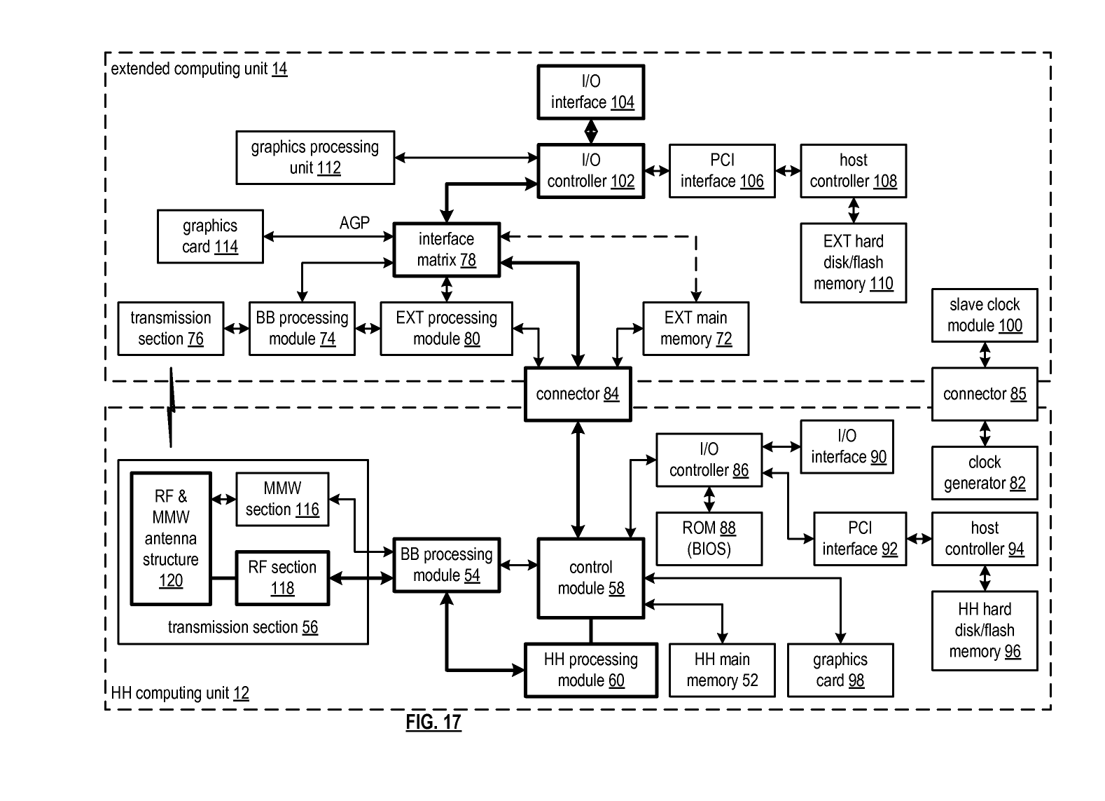

FIG. 16 is a logic diagram of a further embodiment of step 290 of FIG. 15 that is based on the interface matrix 78 being in the EXT computing unit 14. This further embodiment method begins at step 320 where the interface matrix 78 interprets the memory response and/or the memory access request to determine a requesting component. The method continues at step 322 where the interface matrix 78 determines whether the requesting component is a handheld computing unit component or an extended computing unit component. This may be done by accessing a mapping of handheld computing unit components and extended computing unit components operably coupled to the control module. The mapping may be created during the loading of an operating system for a docked mode of operation.

If, at step 322, the requesting component is an EXT component, the method continues at step 324 where the interface matrix 78 determines an output for the EXT component based on the mapping. If, at step 322, the requesting component is an HH component, the method continues at step 326 where the interface matrix 78 determines whether to communicate (e.g., transmit the memory response) with the HH component via a wired communication path (e.g., via the connector 84) or a wireless communication path (e.g., via the baseband processing modules and the corresponding transmission sections). The determination of which path to use may be based on availability of the wireless communication path, availability of the wired communication path, amount of data contained in the memory response, a predetermined setting, error rate of the wireless communication path, bandwidth of the wireless communication path, bandwidth of the wired communication path, and/or sensitivity of the data contained in the memory response.

When the wired path is used, the method continues at step 328 where the interface matrix 78 identifies the output coupled to the connector based on the mapping. When the wireless path is used, the method continues at step 330 where the interface matrix 78 identifies the output coupled to the baseband processing module based on the mapping. The method continues at step 332 where the baseband processing module receives the representation of the memory response, which includes an identification code of the requesting component. The method continues at step 334 where the baseband processing module converts the representation of the memory response into the outbound symbol stream.

The method of FIG. 11 is applicable to the interface matrix 78 being in the HH computing unit 12 with the decision of step 322 being reversed. For instance, with the interface matrix 78 in the HH unit 12, if the requesting component is an HH component, the method continues at step 324 where the interface matrix 78 identifies the output based on the mapping of the HH component to the output. If the requesting component is an EXT component, the method continues at step 326.

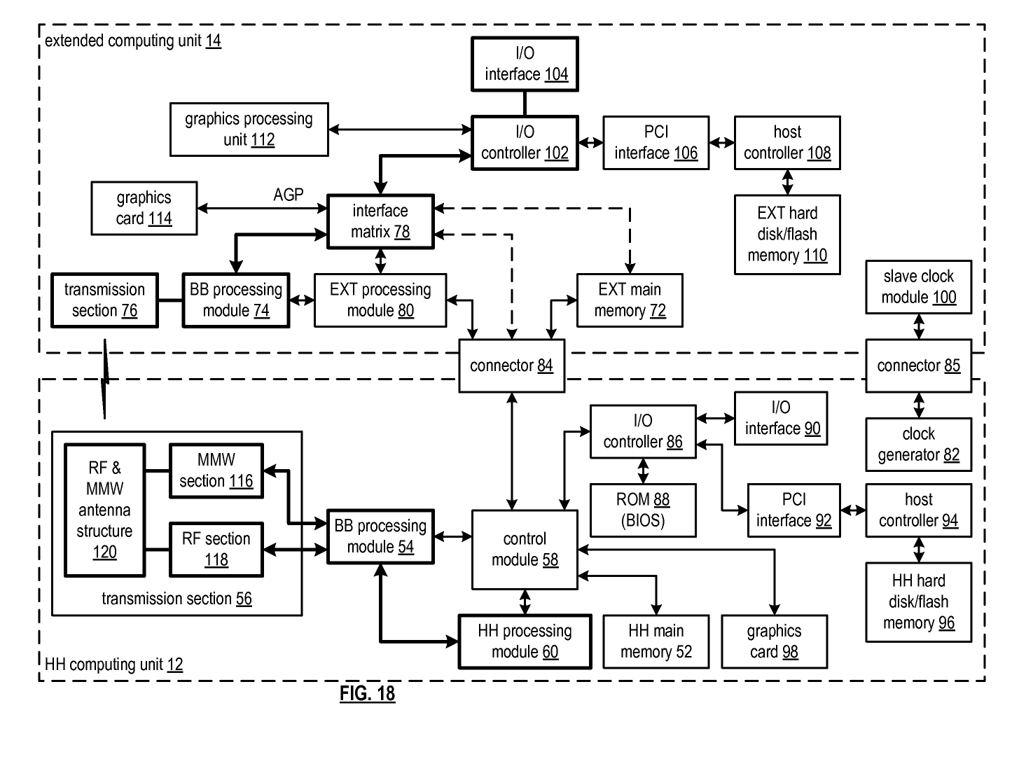

FIG. 17 is a schematic block diagram of an example of the computing device 10 executing a cellular telephone call. In this example, the HH computing unit 12 is docked to the extended computing unit 14, where the microphone and speakers or headset of the EXT provide the user input and output for the cellular telephone call. The components of the HH unit 12 and the EXT unit 14 that are involved in the cellular communication are shown in bold lines.

For an incoming cellular telephone call, the RF & MMW antenna structure 120 receives an inbound cellular RF signal and provides it to the RF section 118. The RF section 118 converts the inbound cellular RF signal into an inbound symbol stream. The baseband processing module 54 converts the inbound symbol stream into inbound data. The HH processing module 60 may perform data link layer function, the network layer function, the transport layer function, the session layer function, the presentation layer function, and the application layer function of the Open Systems Interconnection Reference Model.

The processing bound data is routed by the control module 58 to the interface matrix 78 via the connector 84. The interface matrix 78, as directed by the control module 58, provides the processed inbound data to the IO controller 102, which provides it to the IO interface 104 coupled to the speakers or headset.

For outgoing cellular data, the microphone of the EXT unit 14 receives a voice signal and converts it into a digital audio signal. The IO interface 104 forwards the digital audio signal to the IO controller 102, which, in turn, provides it to the interface matrix 78. The interface matrix 78 interprets the digital audio signal to determine that it is to be forwarded to the control module 58.

The control module 58 provides the digital audio signal to the HH processing module for higher layer OSI model processing to produce outbound data. The baseband processing module converts the outbound data into an outbound symbol stream. The RF section 118 converts the outbound symbol stream into an outbound cellular RF signal that is transmitted via the RF & MMW antenna structure 120.

FIG. 18 is a schematic block diagram of another example of the computing device 10 executing a cellular telephone call. In this example, the HH computing unit 12 is docked to the extended computing unit 14, where the microphone and speakers or headset of the EXT provide the user input and output for the cellular telephone call. The components of the HH unit 12 and the EXT unit 14 that are involved in the cellular communication are shown in bold lines and the docking is via the wireless communication path (e.g., a MMW local bus) provided by the baseband processing modules 54 and 74 and the transmissions sections 56 and 76.

For an incoming cellular telephone call, the RF & MMW antenna structure 120 receives an inbound cellular RF signal and provides it to the RF section 118. The RF section 118 converts the inbound cellular RF signal into an inbound symbol stream. The baseband processing module 54 converts the inbound symbol stream into inbound data. The HH processing module 60 may perform data link layer function, the network layer function, the transport layer function, the session layer function, the presentation layer function, and the application layer function of the Open Systems Interconnection Reference Model. Note that the higher layer processing may be skipped by the HH processing module 60 if subsequently performed by the EXT processing unit 80.

The processed inbound data is routed back to the baseband processing module 54 for conversion into a MMW bus outbound symbol stream. The MMW section 116 converts the MMW bus outbound symbol stream into an outbound MMW signal that is transmitted by the MMW portion of the RF & MMW antenna structure 120. The transmission section 76, which includes a MMW antenna structure, receives the MMW signal and converts it into a MMW bus inbound symbol stream. The baseband processing module 74 converts the MMW bus inbound symbol stream into MMW bus inbound data.

The baseband processing module 74 provides the MMW bus inbound data to EXT processing module 80 for further processes (if needed) or to the interface matrix 78. The interface matrix 78 provides the processed inbound data to the IO controller 102, which provides it to the IO interface 104 coupled to the speakers or headset.

For outgoing cellular data, the microphone of the EXT unit 14 receives a voice signal and converts it into a digital audio signal. The IO interface 104 forwards the digital audio signal to the IO controller 102, which, in turn, provides it to the interface matrix 78. The interface matrix 78 interprets the digital audio signal to determine that it is to be forwarded to the HH unit via the wireless communication path (e.g., the MMW bus).

If the higher OSI model layers are performed by the EXT processing module, the interface matrix 78 provides the digital audio signal to the processing module 80 for processing. If the higher OSI model layers are performed by the HH processing module, the interface matrix 78 provides the digital audio signal to the baseband processing module 74. In either case, the baseband processing module converts the outbound signal into an outbound symbol stream. The transmission section 76 converts the outbound symbol stream into an outbound MMW signal.

The MMW section 116 receives the MMW signal and converts it into an inbound symbol stream. The baseband processing module converts the inbound symbol stream into inbound data, which may be further processed by the HH processing module 60, if not already done. The baseband processing module 54 then converts the recovered inbound data into an outbound symbol stream. The RF section 118 converts the outbound symbol stream into an outbound cellular RF signal that is transmitted via the RF & MMW antenna structure 120.

FIG. 19 is a schematic block diagram of an example of the computing device 10 executing video graphics processing. In this example, the HH computing unit 12 is docked to the extended computing unit 14, where the display coupled to the graphics card 114 of the EXT unit 14 provides the user graphics output of the computing device 10. The components of the HH unit 12 and the EXT unit 14 that are involved in the video graphics processing are shown in bold lines and the docking is via the wireless communication path (e.g., a MMW local bus) provided by the baseband processing modules 54 and 74 and the transmissions sections 56 and 76.

For retrieval of graphics data stored in the EXT main memory 72, the interface matrix 78 functions similarly to a memory controller providing an accelerated graphics port and/or a PCI express interface. For retrieval of graphics data stored in the HH main memory 52, the interface matrix 78 receives a graphics data request from the graphics card 114 and provides it to the baseband processing module 74. The baseband processing module 74 converts the graphics data request into an outbound symbol stream. The transmission section 76 converts the outbound symbol stream into an outbound MMW signal that is transmitted to the HH computing unit.

The MMW section 116 receives the MMW signal and converts it into an inbound symbol stream. The baseband processing module 54 converts the inbound symbol stream into inbound data to recover the graphics data request and provides it to the control module 58. The control module 58 interprets the graphics request and addresses the HH main memory to retrieve the requested graphics data. The control module 58 provides the retrieved graphics data to the baseband processing module 54 for conversion into an outbound symbol stream. The MMW section 116 converts the outbound symbol stream into an outbound MMW signal.

The transmission section 76 receives the MMW signal and converts it into a MMW bus inbound symbol stream. The baseband processing module 74 converts the MMW bus inbound symbol stream into recovered graphics data. The baseband processing module 74 provides the recovered graphics data to the interface matrix 78, which provides the graphics data to the graphics card 114.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “operably coupled to”, “coupled to”, and/or “coupling” includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item. As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

1. A computing unit comprises:
main memory;
a processing module;
a baseband processing module operably coupled to:
convert outbound data into an outbound symbol stream; and
convert an inbound symbol stream into inbound data;
a transmission section operably coupled to:
convert the outbound symbol stream into an outbound wireless signal; and
convert an inbound wireless signal into the inbound symbol stream;
a control module having a plurality of inputs, a plurality of outputs, and a plurality of memory interfaces, wherein the main memory is coupled to one of the plurality of memory interfaces, the processing module is coupled to one of the plurality of inputs and to one of the plurality of outputs, and the baseband processing module is coupled to another one of the plurality of inputs and to another one of the plurality of outputs, wherein the control module is operably coupled to:
receive a request via a input of the plurality of inputs;
interpret the request;
when the request is a memory access request, determine an address from the memory access request;
determine a memory interface of the plurality of memory interfaces based on the address; and
transmit a representation of the memory access request to the memory interface.

2. The computing unit of claim 1, wherein the control module is further operably coupled to:
receive a memory response via the memory interface;
determine a output of the plurality of outputs based on at least one of the memory response and the memory access request; and
transmit a representation of the memory response to the output.

3. The computing unit of claim 2, wherein the control module is further operably coupled to determine the output by:
interpreting the at least one of the memory response and the memory access request to determine a requesting component;
determining whether the requesting component is a handheld computing unit component or an extended computing unit component;
when the requesting component is an extended computing unit component, determining whether the representation of the memory response will be transmitted to the request component via a wired communication path or a wireless communication path; and
when the representation of the memory response will be transmitted via the wireless communication path, identifying the output as the another one of the plurality of outputs coupled to the baseband processing module, wherein the representation of the memory response includes the memory response, an interpretation of the memory response, a re-packetization of the memory response, a signal transformation of the memory response, or a portion of the memory response.

4. The computing unit of claim 3, wherein the baseband processing module is further operably coupled to:
receive the representation of the memory response, which includes an identification code of the requesting component; and
convert the representation of the memory response into the outbound symbol stream.

5. The computing unit of claim 3, wherein the control module is further operably coupled to determine whether the representation of the memory response will be transmitted to the request component via a wired communication path or a wireless communication path by:
determining at least one of availability of the wireless communication path, availability of the wired communication path, amount of data contained in the memory response, a predetermined setting, error rate of the wireless communication path, bandwidth of the wireless communication path, bandwidth of the wired communication path, and sensitivity of the data contained in the memory response.

6. The computing unit of claim 3, wherein the control module is further operably coupled to determine whether the requesting component is a handheld computing unit component or an extended computing unit component by:
accessing a mapping of handheld computing unit components and extended computing unit components operably coupled to the control module, wherein the mapping is created during loading of an operating system for a docked mode of operation.

7. The computing unit of claim 1, wherein the control module is further operably coupled to:
for each of the plurality of memory interfaces, determine whether it is coupled to a handheld computing unit main memory, an extended computing unit main memory, or not coupled to a main memory;
for each memory interface coupled to a handheld computing unit main memory or to an extended computing unit main memory, determine physical addresses for the handheld computing unit main memory or the extended computing unit main memory; and
for each of the handheld computing unit main memory or the extended computing unit main memory, map the physical addresses to a virtual memory space.

8. The computing unit of claim 1, wherein the control module is further operably coupled to determine the memory interface by:
determine whether the address is associated with a handheld computing unit main memory or an extended computing unit main memory;
when the address is associated with the handheld computing unit main memory, utilize a first memory interface of the plurality of memory interfaces; and
when the address is associated with the extended computing unit main memory, utilize a second memory interface of the plurality of memory interfaces.

9. The computing unit of claim 1, wherein the control module further comprises:
a input processing unit operably coupled to the plurality of inputs and to the plurality of memory interfaces;
a memory access processing unit operably coupled to the input processing unit and to the plurality of memory interfaces;
a buffer module coupled to the plurality of memory interfaces; and
an output processing unit coupled to the buffer module, the memory access processing unit, and the plurality of outputs.

10. The computing unit of claim 1, wherein the control module is further operably coupled to:
when the request is a processing module access request, identify the one of the plurality of outputs coupled to the processing module;
transmit a representation of the processing module access request to the one of the plurality of outputs;
receive a processing module response via the one of the plurality of inputs coupled to the processing module;
identify a requesting component based on the input;
determine a output of the plurality of outputs based on the identity of the requesting component; and
transmit a representation of the processing module response to the output.

11. The computing unit of claim 1, wherein the control module is further operably coupled to:
when the request is a baseband processing module access request, identify the another one of the plurality of outputs coupled to the baseband processing module;
transmit a representation of the baseband processing module access request to the another one of the plurality of outputs;
receive a baseband processing module response via the another one of the plurality of inputs coupled to the baseband processing module;
identify a requesting component based on the input;
determine a output of the plurality of outputs based on the identity of the requesting component; and
transmit a representation of the baseband processing module response to the output.

12. The computing unit of claim 1 further comprises:
an integrated circuit supporting at least one of the processing module, the baseband processing module, the transmission section, and the control module.

13. A computing device comprises:
a handheld (HH) computing unit that includes:
HH main memory;
an HH processing module;
an HH baseband processing module operably coupled to:
convert HH outbound data into an HH outbound symbol stream; and
convert an HH inbound symbol stream into HH inbound data;
an HH transmission section operably coupled to:
convert the HH outbound symbol stream into an HH outbound wireless signal; and
convert an HH inbound wireless signal into the HH inbound symbol stream;
a control module having a plurality of inputs, a plurality of outputs, and a plurality of memory interfaces, wherein the HH main memory is coupled to one of the plurality of memory interfaces, the HH processing module is coupled to one of the plurality of inputs and to one of the plurality of outputs, and the HH baseband processing module is coupled to another one of the plurality of inputs and to another one of the plurality of outputs, wherein the control module is operably coupled to:
receive a request via a input of the plurality of inputs;
interpret the request;
when the request is a memory access request, determine an address from the memory access request;
determine a memory interface of the plurality of memory interfaces based on the address; and
transmit a representation of the memory access request to the memory interface; and
an extended (EXT) computing unit that includes.
EXT main memory;
an EXT processing module;
an EXT baseband processing module operably coupled to:
convert EXT outbound data into an EXT outbound symbol stream; and
convert an EXT inbound symbol stream into EXT inbound data;
an EXT transmission section operably coupled to:
convert the EXT outbound symbol stream into an EXT outbound wireless signal; and
convert an EXT inbound wireless signal into the EXT inbound symbol stream;
an interface matrix having a plurality of inputs, a plurality of outputs, and an computing unit interface, wherein the EXT main memory and the EXT processing module are coupled to the computing unit interface and the EXT baseband processing module is coupled to one of the plurality of inputs and to one of the plurality of outputs,

14. The computing device of claim 13, wherein the interface matrix is operably coupled to:
receive an input signal via an input of the plurality of inputs;
interpret the input signal; and
when the input signal is an EXT memory access request, transmit a representation of the EXT memory access request to the computing unit interface.

15. The computing device of claim 13, wherein the interface matrix is further operably coupled to:
receive a memory response via the computing unit interface;
determine an output of the plurality of outputs based on at least one of the memory response and the input signal; and
transmit a representation of the memory response to the output.

16. The computing device of claim 15, wherein the interface matrix is further operably coupled to determine the output by:
interpreting the at least one of the memory response and the memory access request to determine a requesting component;
determining whether the requesting component is a handheld computing unit component or an extended computing unit component;
when the requesting component is a handheld computing unit component, determining whether the representation of the memory response will be transmitted to the request component via a wired communication path or a wireless communication path; and
when the representation of the memory response will be transmitted via the wireless communication path, identifying the output as the one of the plurality of outputs coupled to the EXT baseband processing module, wherein the representation of the memory response includes the memory response, an interpretation of the memory response, a re-packetization of the memory response, a signal transformation of the memory response, or a portion of the memory response.

17. The computing device of claim 13, wherein the control module further comprises:
a input processing unit operably coupled to the plurality of inputs and to the plurality of memory interfaces;
a memory access processing unit operably coupled to the input processing unit and to the plurality of memory interfaces;
a buffer module coupled to the plurality of memory interfaces; and
an output processing unit coupled to the buffer module, the memory access processing unit, and the plurality of outputs.

18. The computing device of claim 13, wherein the interface matrix is further operably coupled to:
when the request is an EXT processing module access request, transmit a representation of the EXT processing module access request to the computing unit interface;
receive an EXT processing module response via the computing unit interface;
identify a requesting component based on the input of the plurality of inputs;
determine an output of the plurality of outputs based on the identity of the requesting component; and
transmit a representation of the EXT processing module response to the output.

19. The computing device of claim 13, wherein the interface matrix is further operably coupled to:
when the request is an EXT baseband processing module access request, identify the one of the plurality of outputs coupled to the EXT baseband processing module;
transmit a representation of the EXT baseband processing module access request to the one of the plurality of outputs;
receive an EXT baseband processing module response via the one of the plurality of inputs coupled to the EXT baseband processing module;
identify a requesting component based on the input of the plurality of inputs;
determine an output of the plurality of outputs based on the identity of the requesting component; and
transmit a representation of the EXT baseband processing module response to the output.

20. A computing unit comprises:
main memory;
a processing module;
a baseband processing module operably coupled to:
convert outbound data into an outbound symbol stream; and
convert an inbound symbol stream into inbound data;
a transmission section operably coupled to:
convert the outbound symbol stream into an outbound wireless signal; and
convert an inbound wireless signal into the inbound symbol stream;
an interface matrix having a plurality of inputs, a plurality of outputs, and an computing unit interface, wherein the main memory and processing module are coupled to the computing unit interface and the baseband processing module is coupled to one of the plurality of inputs and to one of the plurality of outputs, wherein the interface matrix is operably coupled to:
receive an input signal via an input of the plurality of inputs;
interpret the input signal; and
when the input signal is a memory access request, transmit a representation of the memory access request to the computing unit interface.

21. The computing unit of claim 20, wherein the interface matrix is further operably coupled to:
receive a memory response via the computing unit interface;
determine an output of the plurality of outputs based on at least one of the memory response and the input signal; and
transmit a representation of the memory response to the output.

22. The computing unit of claim 21, wherein the interface matrix is further operably coupled to determine the output by:
interpreting the at least one of the memory response and the memory access request to determine a requesting component:
determining whether the requesting component is a handheld computing unit component or an extended computing unit component;
when the requesting component is a handheld computing unit component, determining whether the representation of the memory response will be transmitted to the request component via a wired communication path or a wireless communication path; and
when the representation of the memory response will be transmitted via the wireless communication path, identifying the output as the to another one of the plurality of outputs coupled to the baseband processing module, wherein the representation of the memory response includes the memory response, an interpretation of the memory response, a re-packetization of the memory response, a signal transformation of the memory response, or a portion of the memory response.

23. The computing unit of claim 20, wherein the interface matrix further comprises:
an input processing unit operably coupled to the plurality of inputs;
an access processing unit operably coupled to the input processing unit and to the computing unit interface; and
an output processing unit coupled to the access processing unit and to the plurality of outputs.

24. The computing unit of claim 20, wherein the interface matrix is further operably coupled to:
when the request is an processing module access request, transmit a representation of the processing module access request to the computing unit interface;
receive a processing module response via the one of the computing unit interface;
identify a requesting component based on the input of the plurality of inputs;
determine an output of the plurality of outputs based on the identity of the requesting component; and
transmit a representation of the processing module response to the output.

25. The computing device of claim 20, wherein the interface matrix is further operably coupled to:
when the request is an baseband processing module access request, identify the one of the plurality of outputs coupled to the baseband processing module;
transmit a representation of the baseband processing module access request to the one of the plurality of outputs;
receive an baseband processing module response via the one of the plurality of inputs coupled to the baseband processing module;
identify a requesting component based on the input of the plurality of inputs;
determine an output of the plurality of outputs based on the identity of the requesting component; and
transmit a representation of the baseband processing module response to the output.

26. The computing unit of claim 20 further comprises:
an integrated circuit supporting at least one of the processing module, the baseband processing module, the transmission section, and the interface matrix.
